(19) United States
(12) Patent Application Publication
(10) Pub. No.: US 2026/0080559 A1
(43) Pub. Date: Mar. 19, 2026

(54) TRIFOCAL BLOCK TENSOR-BASED SYNCHRONIZATION IN COMPUTER VISION AND SENSOR SYSTEM

(71) Applicants: BOARD OF REGENTS, THE UNIVERSITY OF TEXAS SYSTEM, Austin, TX (US); UNIVERSITY OF MINNESOTA, Minneapolis, MN (US)

(72) Inventors: Gilad LERMAN, Minneapolis, MN (US); Joseph David KILEEL, Austin, TX (US); Daniel MIAO, Minneapolis, MN (US)

(21) Appl. No.: 19/328,427

(22) Filed: Sep. 15, 2025

Related U.S. Application Data
(60) Provisional application No. 63/694,595, filed on Sep. 13, 2024.

(51) Int. Cl. G06T 7/70; G06T 5/70; G06T 17/00; G06V 20/70

(52) U.S. Cl. CPC G06T 7/70; G06T 5/70; G06T 17/00; G06V 20/70; G06T 2207/20182; G06T 2207/30244

(57) ABSTRACT

An exemplary tensor-based synchronization system and method are disclosed that employ block trifocal or quadrifocal tensors using the higher-order relative measurements encoded in trifocal or quadrifocal tensors to operate on projective, calibrated, or partially calibrated information between images to determine camera poses, such as locations and orientations. The block tensor of trifocal or quadrifocal tensors can provide crucial geometric information on the three-view geometry of a scene. The underlying synchronization problem can recover camera poses (locations and orientations up to a global transformation) from the block trifocal tensor.

### RELATED APPLICATIONS

This U.S. application claims priority to, and the benefit of, U.S. Provisional Patent Application No. 63/694,595, filed Sep. 13, 2024, entitled “TRIFOCAL BLOCK TENSOR-BASED SYNCHRONIZATION IN COMPUTER VISION AND SENSOR SYSTEM,” which is incorporated by reference herein in its entirety.

### STATEMENT REGARDING FEDERALLY SPONSORED RESEARCH OR DEVELOPMENT

This invention was made with government support under Grant numbers DMS2309782, DMS2152766, and U.S. Pat. No. 2,312,746 awarded by the National Science Foundation. The government has certain rights in the invention.

### BACKGROUND

Synchronization problems in computer vision are employed in many data-intensive applications. Synchronization involves estimating global states from relative measurements between states. Many studies have explored synchronization in different contexts using pairwise measurements.

Synchronization is crucial for the success of many data-intensive applications, including structure from motion, simultaneous localization and mapping (SLAM), and community detection. This problem involves estimating global states from relative measurements between states. While many studies have explored synchronization in different contexts using pairwise measurements, few have considered measurements between three or more states. In real-world scenarios, relying solely on pairwise measurements often fails to capture the full complexity of the system. For instance, in networked systems, interactions frequently occur among groups of nodes, necessitating approaches that can handle higher-order relationships. Extending synchronization to consider measurements between three or more states, however, increases computational complexity and requires sophisticated mathematical models.

There are, nevertheless, benefits to improving the underlying synchronization problem and computation operation for various computer vision and sensor applications.

### SUMMARY

An exemplary tensor-based synchronization system and method are disclosed that employ block trifocal or quadrifocal tensors using the higher-order relative measurements encoded in trifocal or quadrifocal tensors to operate on projective, calibrated, or partially calibrated information between images to determine camera poses, such as locations and orientations. The block tensor of trifocal or quadrifocal tensors can provide crucial geometric information on the three-view geometry of a scene. The underlying synchronization problem can recover camera poses (locations and orientations up to a global transformation) from the block trifocal or quadrifocal tensor. Tensor operations can be readily partitioned to distribute the processing for a large data set of images, video, or computer objects.

An explicit Tucker factorization of the tensor may be employed, in some embodiments, to determine a low-multilinear rank of (6,4,4) (for trifocal) independent of the number of cameras when performed under appropriate scaling conditions. The constraint or analogous low multilinear rank constraints may be employed in a synchronization algorithm based on the higher-order singular value decomposition of the block trifocal or quadrifocal tensor. The rank constraint can provide sufficient information for camera recovery in a noiseless analysis. The constraint may be employed in a synchronization algorithm based on the higher-order singular value decomposition of the block trifocal or quadrifocal tensor. Experimental comparisons with state-of-the-art global synchronization methods on real datasets demonstrate the benefit of the algorithm in significantly improving location estimation accuracy. Other higher-order interactions in synchronization problems can be exploited to improve the performance beyond the usual pairwise-based approaches.

In an aspect, a method is disclosed comprising receiving a plurality of images acquired from a plurality of cameras, including a first camera and a second camera (e.g., each or some having unspecified distance and orientation from one another); reconstructing, via a computer vision application (e.g., 3D scene perception and reconstruction computer application, e.g., structure-from-motion computer vision application, VINS, self-driving cars, or SLAM), a 3D world scene from the plurality of images (e.g., as unordered set of 2D images); determining, via a synchronization operation, a global tensor estimate or a camera global tensor estimate using triplewise or quadruplewise relative pose estimates, wherein individual triplewise or quadruplewise relative poses (i) employ one or more arrays (e.g., 3×3×3 overlapping arrays of numbers) comprising a subset of trifocal or quadrifocal tensors defined up to nonzero scales and (ii) assemble the array blockwise into one or more tensors (e.g., 3n×3n×3n tensors, or incomplete tensors, where n is the number of images in the dataset; could have subtensors in the 3n×3n×3n tensor, or incomplete subtensors; or K tensors when the synchronization operation is performed in a distributed manner); and outputting the global tensor estimate (e.g., corresponding camera pose, orientation) for visualization (e.g., in a photo tourism application) or control.

In some embodiments, the synchronization operation is performed in a distributed manner, the synchronization operation comprising: distributing the plurality of images among a set of computing resources, wherein each computing resources is configured to perform a portion of the synchronization operation for a subset of the plurality of images to determine a subset of the triplewise or quadruplewise relative poses; and merging the subset of triplewise or quadruplewise relative pose estimates for the subsets of the plurality of images.

In some embodiments, the method disclosed herein comprising updating the global tensor estimates to remove noise and provide fuller observation using an iterative algorithm to compute correct scales, impute missing blocks, and denoise the global tensor; and performing imputation of synchronization by (i) computing a higher-order singular value decomposition (or robust variant thereof) or an alternating direction method of multipliers and (ii) reading off the global configuration from the factor matrices.

In some embodiments, the plurality of images are utilized in photo tourism applications (e.g., Google Street View, self-driving car technologies, and unmanned aerial vehicles).

In some embodiments, the method includes applying a constraint low-multilinear rank operation in the synchronization operation.

In some embodiments, the constraint low-multilinear rank is determined via explicit Tucker factorization of the tensor.

In some embodiments, the constraint low-multilinear rank is (6,4,4) (e.g., independent of the number of cameras).

In some embodiments, the constraint low-multilinear rank is (4, 6, 4), (4, 4, 6), or other permutations thereof (e.g., to determine scales in the one or more tensors; fitting scales to the one or more tensors to satisfy the rank constraints).

In some embodiments, the constraint low-multilinear rank is (4,4,4,4) when the one or more tensors are quadrifocal.

In some embodiments, the one or more tensors have a constraint low-multilinear rank and low p-rank, wherein the p-rank is (4,3,3) when the one or more tensors are trifocal. When the one or more tensors are quadrifocal, the ranks of random linear combinations of matrix slices of the one or more tensors are (4,4,4,4,4,4), since there are 6 ways to project the one or more tensors to a matrix (e.g., where the p-rank is a projection rank comprising ranks of matrices that arise as generic contractions of the tensor).

In some embodiments, the synchronization operation employs a Tyler M estimator for subspace recovery.

In some embodiments, the synchronization operation, as a distributed operation, comprises: partitioning a dataset into k parts (e.g., randomly or algorithmically) so that each overlapping partition has at most a pre-defined number of cameras (e.g., 60 cameras); labeling the partitions and add 2×k cameras from the (i+1)th partition into the ith partition, where the added cameras from the (i+1)th partition are densest connected cameras to the ith partition; synchronizing each sub dataset using the tensor synchronization algorithm; and computing a homography using the overlapping cameras and bring all subproblems to a same projective, calibrated, or partially calibrated frame to achieve a large reconstruction.

In some embodiments, the overlapping partitions have the same or different cameras, and the overlapping partitions have at least 10 indices or cameras in common.

In another aspect, a non-transitory computer-readable medium is disclosed having instructions stored thereon, where execution of the instructions by a processor causes the processor to receive a plurality of images acquired from a plurality of cameras, including a first camera and a second camera (e.g., each or some having unspecified distance and orientation from one another); reconstruct, via a computer vision application (e.g., 3D scene perception and reconstruction computer application, e.g., structure-from-motion computer vision application, VINS, self-driving cars, or SLAM), a 3D world scene from the plurality of images (e.g., as an unordered set of 2D images); determine, via a synchronization operation, a global tensor estimate or a camera global tensor estimate using triplewise or quadruplewise relative pose estimates, wherein individual triplewise or quadruplewise relative poses (i) employ one or more arrays (e.g., 3×3×3 overlapping arrays of numbers) comprising a subset of trifocal or quadrifocal tensors defined up to nonzero scales and (ii) assemble the array blockwise into one or more tensors (e.g., 3n×3n×3n tensors, or incomplete tensors, where n is the number of images in the dataset; could have subtensors in the 3n×3n×3n, or incomplete subtensors; or K tensors when the synchronization operation is performed in a distributed manner); and output the global tensor estimate (e.g., corresponding camera pose, orientation) or the camera instance global tensor estimate for visualization (e.g., in a photo tourism application) or control.

In some embodiments, the execution of the instructions further causes the processor to update the global tensor estimates to remove noise and provide fuller observation using an iterative algorithm to compute correct scales, impute missing blocks, and denoise the global tensor; and perform imputation of synchronization by (i) computing a higher-order singular value decomposition (e.g., or a robust variant thereof) or an alternating direction method of multipliers and (ii) reading off the global configuration from the factor matrices.

In some embodiments, the execution of the instructions further causes the processor to apply a constraint low-multilinear rank operation in the synchronization operation.

In some embodiments, the constraint low-multilinear rank is determined via explicit Tucker factorization of the tensor.

In some embodiments, the constraint low-multilinear rank is (6,4,4).

In another aspect, a system is disclosed comprising a processor; and a memory having instructions stored thereon, where execution of the instructions by the processor causes the processor to receive a plurality of images acquired from a plurality of cameras, including a first camera and a second camera (e.g., each or some having unspecified distance and orientation from one another); reconstruct, via a computer vision application (e.g., 3D scene perception and reconstruction computer application, e.g., structure-from-motion computer vision application, VINS, self-driving cars, or SLAM), a 3D world scene from the plurality of images (e.g., as an unordered set of 2D images); determine, via a synchronization operation, a global tensor estimate or a camera global tensor estimate using triplewise or quadruplewise relative pose estimates, wherein individual triplewise or quadruplewise relative poses (i) employ one or more arrays (e.g., 3×3×3 overlapping arrays of numbers) comprising a subset of trifocal or quadrifocal tensors defined up to nonzero scales and (ii) assemble the array blockwise into one or more tensors (e.g., 3n×3n×3n tensors, or incomplete tensors, where n is the number of images in the dataset; could have subtensors in the 3n×3n×3n, or incomplete subtensors; or K tensors when the synchronization operation is performed in a distributed manner); and output the global tensor estimate (e.g., corresponding camera pose, orientation) or the camera instance global tensor estimate for visualization (e.g., in a photo tourism application) or control.

In some embodiments, the execution of the instructions further causes the processor to update the global tensor estimates to remove noise and provide fuller observation using an iterative algorithm to compute correct scales, impute missing blocks, and denoise the global tensor; and perform imputation of synchronization by (i) computing a higher-order singular value decomposition (e.g., or a robust variant thereof) or an alternating direction method of multipliers and (ii) reading off the global configuration from the factor matrices.

### BRIEF DESCRIPTION OF THE DRAWINGS

FIG. 1A shows an example computer vision system comprising a plurality of cameras, a trifocal block tensor-based synchronization module, a visualization/rendering module, a real-world scene reconstruction module, and a user device.

FIG. 1B shows an example computer vision system comprising a single camera, a trifocal block tensor-based synchronization module, a visualization/rendering module, a real-world scene reconstruction module, and a user device.

FIG. 1C shows an example sensor system comprising a plurality of Light Detection and Ranging (LIDAR) sensors, a trifocal block tensor-based synchronization module, a visualization/rendering module, a real-world scene reconstruction module, and a user device.

FIG. 1D shows an example distributed computer vision system configured to perform trifocal block tensor-based synchronization.

FIG. 2A shows an operational flow of the exemplary synchronization method employed in a computer vision system.

FIG. 2B shows an operational flow of the exemplary synchronization method employed in a sensor system.

FIG. 2C shows an operational flow of an algorithmic implementation of the exemplary synchronization method.

FIG. 2D shows an operational flow of the exemplary synchronization method implemented as a distributed operation in a computer vision system.

FIG. 2E shows an operational flow of the exemplary synchronization method implemented as a distributed operation in a sensor system.

FIGS. 3A-3B shows an example algorithmic implementation for the exemplary synchronization method. Specifically, FIG. 3A shows an example algorithm for an adapted truncation process employed by the exemplary method.

FIG. 3B shows an example algorithm for synchronizing the block trifocal tensor using block scale recovery.

FIGS. 4A-4C each shows an example application utilizing the tensor-based synchronization system and method in accordance with an illustrative embodiment.

FIGS. 5A and 5B show experimental results of the synchronization methods.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

### Example System #1

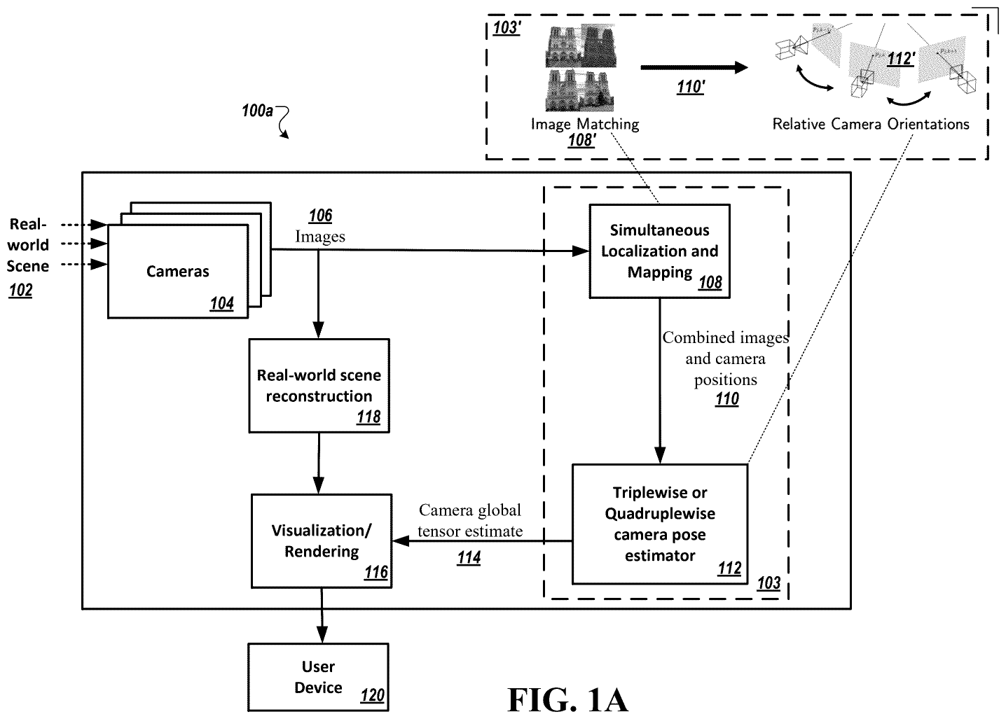

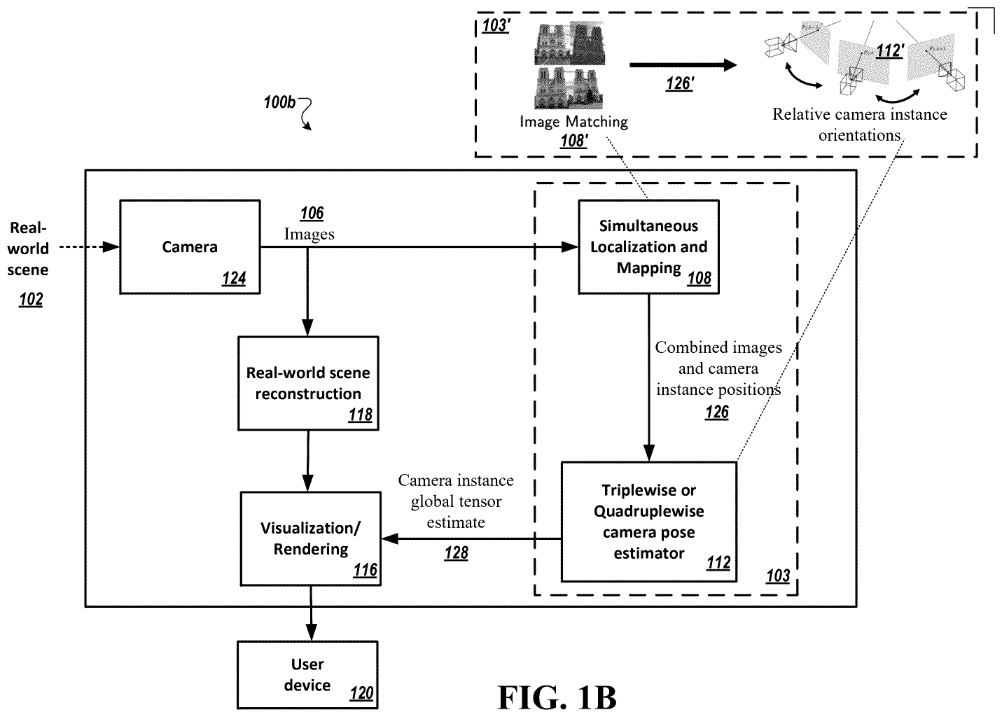

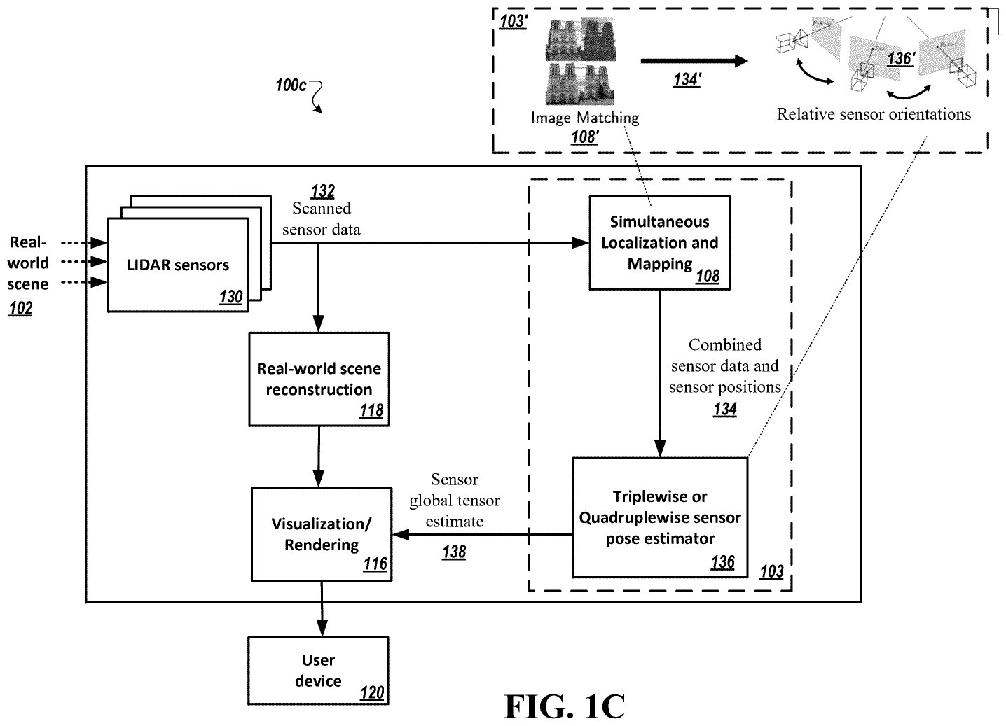

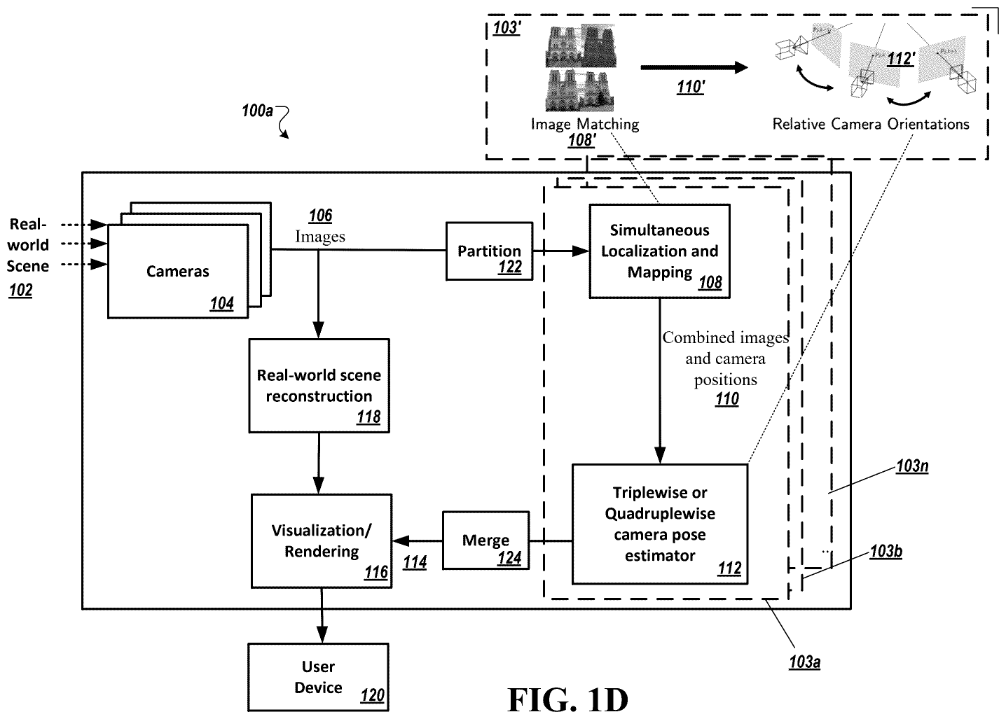

FIG. 1A shows an example computer vision system 100a comprising a plurality of cameras 104, a set of one or more trifocal or quadrifocal block tensor-based synchronization module 103 (also referred to as 103′), a visualization/rendering module 116, a real-world scene reconstruction module 118, and a user device 120. A single trifocal or quadrifocal block tensor-based synchronization module 103 may be employed, or a set of single trifocal or quadrifocal block tensor-based synchronization modules 103 may be performed for distributed operations. FIG. 1D shows an example distributed computer vision system 100d configured to perform distributed synchronization, trifocal block tensor-based synchronization.

As shown in FIGS. 1A and 1D, a plurality of cameras 104, including one or more cameras, is configured to capture a real-world scene 102 and generate images 106 of the real-world scene. Each camera has an unspecified distance and orientation from the others.

The trifocal or quadrifocal block tensor-based synchronization module 103, coupled with the plurality of cameras 104, comprises a simultaneous localization and mapping (SLAM) module 108 (also referred to as 108′) and a triplewise or quadruplewise camera pose estimator 112 (also referred to as 112′). The SLAM module 108 receives the images 106 from the cameras 104 and extracts image features from the images 106. The SLAM module then estimates camera positions and generates combined images by mapping (i.e., matching) the images 106 together using the extracted image features.

The triplewise or quadruplewise camera pose estimator 112, coupled with the SLAM module, receives the combined images and camera positions 110 (also referred to as 110′) generated from the SLAM module 108. The triplewise camera pose estimator generates a camera global tensor estimate 114 (e.g., relative camera orientations) using triplewise relative pose estimates (not shown). The triplewise or quadruplewise camera pose estimator 112 also updates the camera global tensor estimate 114 to remove noise and provide fuller observation using an iterative algorithm to compute correct scales, input missing tensor blocks, and denoise the camera global tensor.

Each triplewise relative pose employs an array (e.g., 3×3×3 arrays of numbers) comprising a subset of trifocal tensors defined up to nonzero scales and assembly the array blockwise into a single tensor (e.g., 3n×3n×3n tensor where n is the number of images in the dataset; may have subtensor in the 3n×3n×3n).

The visualization/rendering module 116, coupled with the triplewise or quadruplewise camera pose estimator 112, receives the camera global tensor estimate 114 from the estimator 112. The visualization/rendering module 116 also employs the real-world scene reconstruction module 118, which receives the images 106 from the cameras 104. Using the real-world scene reconstruction module 118 and the camera global tensor estimate 114, the visualization/rendering module 116 reconstructs and transmits the real-world scene to the user device 120 for demonstration (e.g., photo tourism application) or control.

In FIG. 1D, the synchronization trifocal block tensor-based synchronization is performed in a distributed manner. The operation may include distributing (e.g., via a partition module 122) the plurality of images among a set of computing resources (shown as 103a, 103b, . . . , 103n), where each computing resources (103a, 103b, . . . , 103n) is configured to perform a portion of the synchronization operation for a subset of the plurality of images to determine a subset of the triplewise or quadruplewise relative pose estimates. The subset of triplewise or quadruplewise relative pose estimates is then merged (e.g., via a merging module 124) for the subsets of the plurality of images.

### Example System #2

FIG. 1B shows an example computer vision system 100b comprising a single camera 124, a trifocal or quadrifocal block tensor-based synchronization module 103 (also referred to as 103′), a visualization/rendering module 116, a real-world scene reconstruction module 118, and a user device 120.

As shown in FIG. 1B, the single camera 124 is configured to capture the real-world scene 102 in a plurality of instances and generate images 106 of the real-world scene. Each camera instance has an unspecified orientation from one another.

The trifocal or quadrifocal block tensor-based synchronization module 103, coupled with the single camera 124, comprises a simultaneous localization and mapping (SLAM) module 108 (also referred to as 108′) and a triplewise or quadruplewise camera pose estimator 112 (also referred to as 112′). The SLAM module 108 receives the images 106 generated from the plurality of camera instances and extracts image features from the images 106. The SLAM module then estimates camera positions and generates combined images by mapping (i.e., matching) the images 106 together using the extracted image features.

The triplewise or quadruplewise camera pose estimator 112, coupled with the SLAM module, receives the combined images and camera instance positions 126 (also referred to as 126′) generated from the SLAM module 108. The triplewise camera pose estimator generates a camera instance global tensor estimate 128 (e.g., relative camera instance orientations) using triplewise relative pose estimates (not shown). The triplewise or quadruplewise camera pose estimator 112 also updates the camera instance global tensor estimate 128 to remove noise and provide fuller observation using an iterative algorithm to compute correct scales, input missing tensor blocks, and denoise the camera instance global tensor.

Each triplewise relative pose employs an array (e.g., 3×3×3 arrays of numbers) comprising a subset of trifocal tensors defined up to nonzero scales and assembly the array blockwise into a single tensor (e.g., 3n×3n×3n tensor where n is the number of images in the dataset; may have subtensor in the 3n×3n×3n).

The visualization/rendering module 116, coupled with the triplewise or quadruplewise camera pose estimator 112, receives the camera instance global tensor estimate 128 from the estimator 112. The visualization/rendering module 116 also employs the real-world scene reconstruction module 118 that receives the images 106 from the camera instances of the single camera 124. Using the real-world scene reconstruction module 118 and the camera instance global tensor estimate 128, the visualization/rendering module 116 reconstructs and transmits the real-world scene to the user device 120 for demonstration (e.g., photo tourism application) or control.

The operation of FIG. 1B can be similarly distributed as described in relation to FIG. 1D.

### Example System #3

FIG. 1C shows an example sensor system 100c comprising a plurality of Light Detection and Ranging (LIDAR) sensors 130, a trifocal or quadrifocal block tensor-based synchronization module 103 (also referred to as 103′), a visualization/rendering module 116, a real-world scene reconstruction module 118, and a user device 120.

As shown in FIG. 1C, a plurality of LIDAR sensors 130, including one or more LIDAR sensors, is configured to scan the real-world scene 102 and generate scanned sensor data 132 of the real-world scene. Each LIDAR sensor has an unspecified distance and orientation from the others.

The trifocal or quadrifocal block tensor-based synchronization module 103, coupled with the plurality of LIDAR sensors 130, comprises a simultaneous localization and mapping (SLAM) module 108 (also referred to as 108′) and a triplewise or quadruplewise sensor pose estimator 136 (also referred to as 136′). The SLAM module 108 receives the scanned sensor data 132 from the LIDAR sensors 130 and extracts data features from the scanned sensor data 132. The SLAM module then estimates sensor positions and generates combined sensor data by mapping (i.e., matching) the scanned sensor data 132 together using the extracted data features.

The triplewise or quadruplewise sensor pose estimator 136, coupled with the SLAM module, receives the combined images and sensor positions 134 (also referred to as 134′) generated from the SLAM module 108. The triplewise or quadruplewise sensor pose estimator generates a sensor global tensor estimate 138 (e.g., relative sensor orientations) using triplewise or quadruplewise relative pose estimates (not shown). The triplewise or quadruplewise sensor pose estimator 136 also updates the sensor global tensor estimate 138 to remove noise and provide fuller observation using an iterative algorithm to compute correct scales, input missing tensor blocks, and denoise the sensor global tensor.

Each triplewise or quadruplewise relative pose employs an array (e.g., 3×3×3 arrays of numbers) comprising a subset of trifocal tensors defined up to nonzero scales and assembly the array blockwise into a single tensor (e.g., 3n×3n×3n tensor where n is the number of images in the dataset; may have subtensor in the 3n×3n×3n).

The visualization/rendering module 116, coupled with the triplewise or quadruplewise sensor pose estimator 136, receives the sensor global tensor estimate 138 from the estimator 136. The visualization/rendering module 116 also employs the real-world scene reconstruction module 118, which receives the scanned sensor data 132 from the LIDAR sensors 130. Using the real-world scene reconstruction module 118 and the sensor global tensor estimate 138, the visualization/rendering module 116 reconstructs and transmits the real-world scene to the user device 120 for demonstration (e.g., photo tourism application) or control.

Example Distributed Synchronization. In the examples shown in FIGS. 1A-1C, the trifocal or quadrifocal block tensor-based synchronization module 103 can be implemented as a distributed operation. The operation may include (i) partitioning a dataset (e.g., images 106, scanned sensor data 132) into k parts (e.g., randomly or algorithmically) so that each overlapping partition has at most a pre-defined number of cameras (e.g., 60 cameras), (ii) labeling the partitions and adding 2×k cameras from the (i+1)th partition into the ith partition, where the added cameras from the (i+1)th partition are a densest connected cameras to the ith partition, (iii) synchronizing each sub-dataset using the tensor synchronization algorithm, and (iv) computing a homography using the overlapping cameras and bringing all subproblems to a same projective, calibrated, or partially calibrated frame (e.g., 110, 126, 134) to achieve a large reconstruction.

In some embodiments, the overlapping partitions in the distributed operation have the same or different cameras, and the overlapping partitions have at least 10 indices or cameras in common.

The distributed operation can be implemented on a cloud infrastructure (e.g., Google Cloud) to support mass gathering and synchronization of images and datasets for large-scale applications (e.g., Google Maps, Apple Maps).

Without the distributed implementation of the module 103, the systems 100a-100c can be used for local visualization or control, such as photo tourism applications, display systems synchronized with parking cameras in cars, etc.

### Example Method

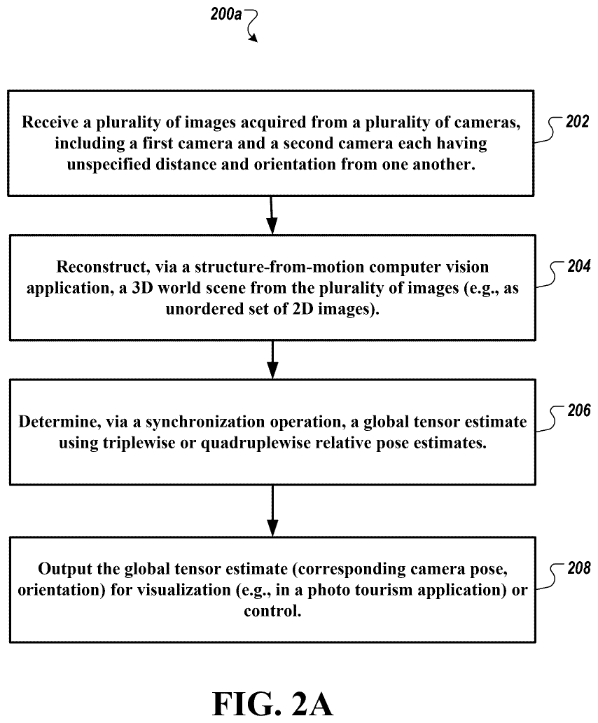

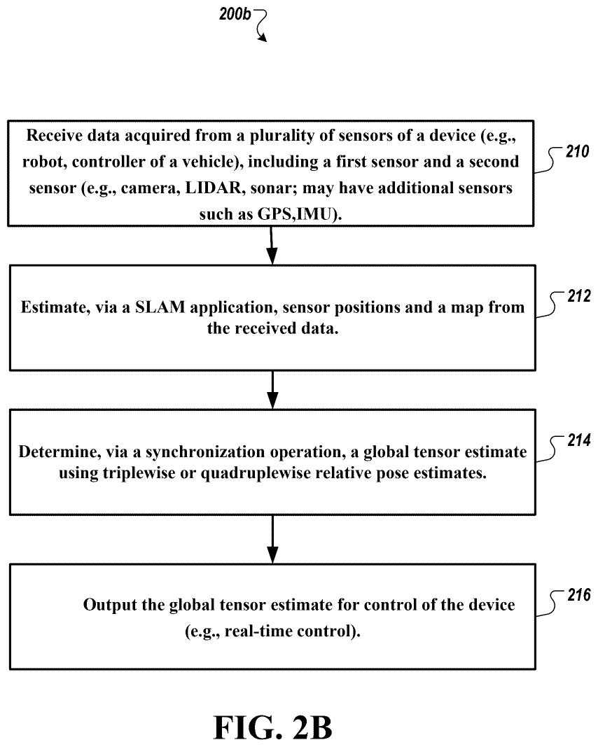

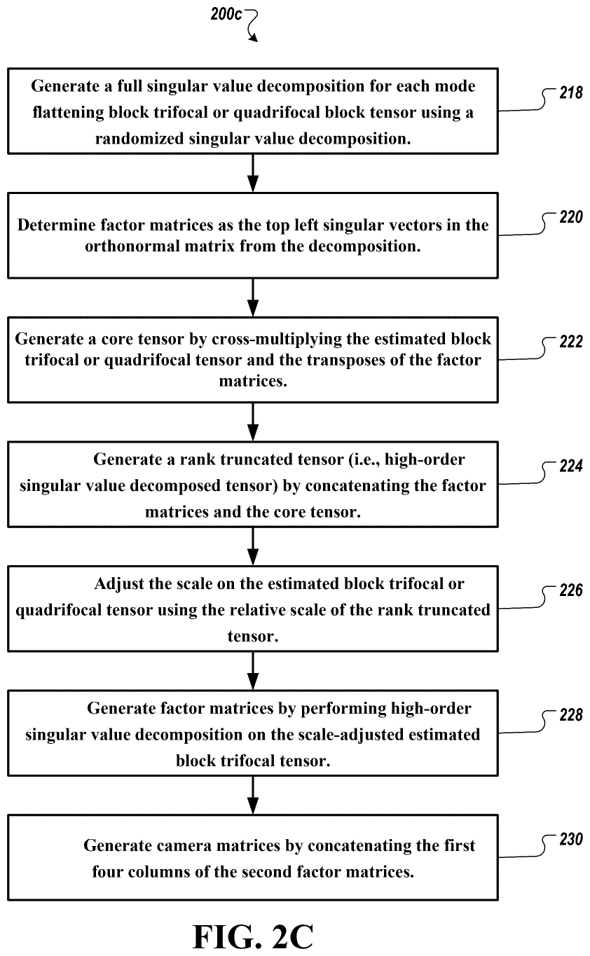

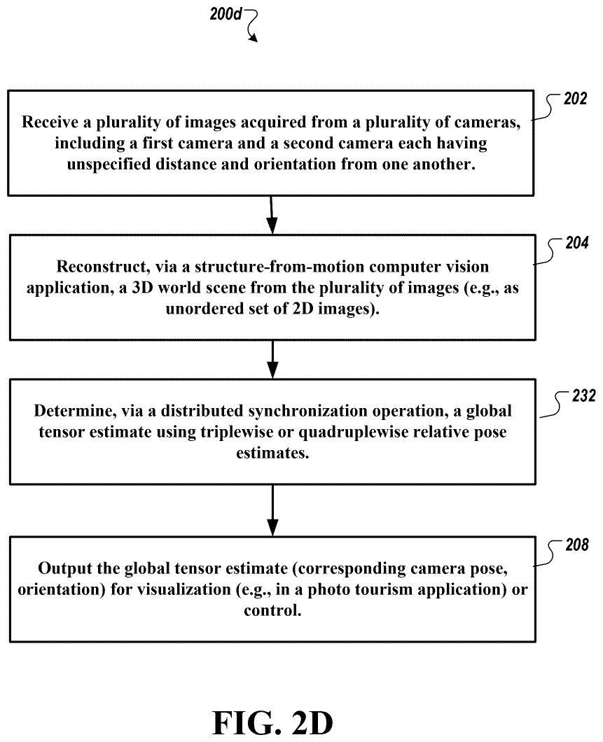

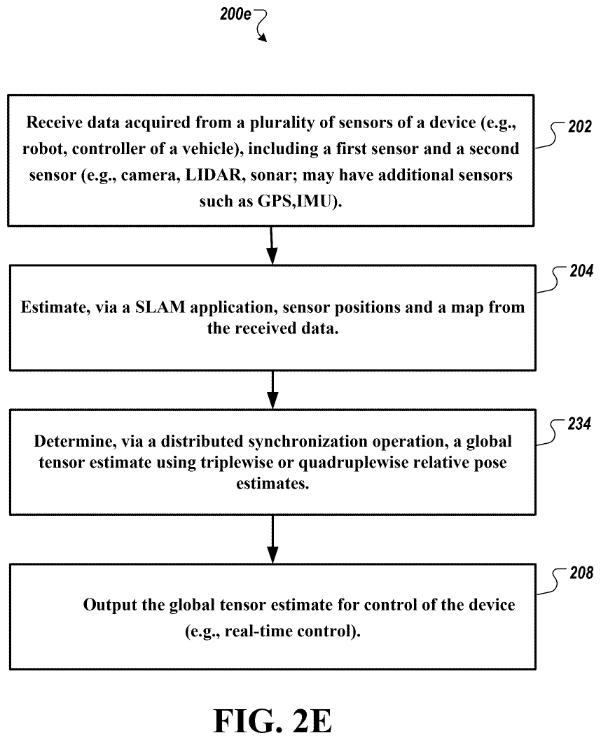

FIG. 2A shows an operational flow 200a of the exemplary synchronization method employed in a computer vision system, which includes 4 steps. At step 202, the exemplary synchronization method receives a plurality of images acquired from a plurality of cameras, including a first camera and a second camera, each having an unspecified distance and orientation from one another.

At step 204, the exemplary synchronization method reconstructs, via a structure-from-motion computer vision application, a 3D world scene from the plurality of images (e.g., as an unordered set of 2D images).

At step 206, the exemplary synchronization method determines, via a synchronization operation, a global tensor estimate using triplewise or quadruplewise relative pose estimates.

At step 208, the exemplary synchronization method outputs the global tensor estimate (e.g., corresponding camera pose, orientation) for visualization (e.g., in a photo tourism application) or control.

FIG. 2B shows an operational flow 200b of the exemplary synchronization method employed in a sensor system, which includes 4 steps. At step 210, the exemplary synchronization method receives data acquired from a plurality of sensors of a device (e.g., robot, controller of a vehicle), including a first sensor and a second sensor (e.g., camera, LIDAR, sonar; may have additional sensors such as GPS, IMU).

At step 212, the exemplary synchronization method estimates, via a SLAM application, sensor positions and a map from the received data.

At step 214, the exemplary synchronization method determines, via a synchronization operation, a global tensor estimate using triplewise or quadruplewise relative pose estimates.

At step 216, the exemplary synchronization method outputs the global tensor estimate for control of the device (e.g., real-time control).

FIG. 2C shows an operational flow 200c of an algorithmic implementation of the exemplary synchronization method, which includes 7 steps. At step 218, the exemplary synchronization method generates a full singular value decomposition for each mode flattening block, trifocal or quadrifocal block tensor, using a randomized singular value decomposition (SVD).

At step 220, the exemplary synchronization method determines factor matrices as the top left singular vectors in the orthonormal matrix from the decomposition.

At step 222, the exemplary synchronization method generates a core tensor by cross-multiplying the estimated block trifocal or quadrifocal tensor and the transposes of the factor matrices.

At step 224, the exemplary synchronization method generates a rank-truncated tensor (i.e., high-order singular value decomposed tensor) by concatenating the factor matrices and the core tensor.

At step 226, the exemplary synchronization method adjusts the scale on the estimated block trifocal or quadrifocal tensor using the relative scale of the rank-truncated tensor.

At step 228, the exemplary synchronization method generates factor matrices by performing high-order singular value decomposition on the scale-adjusted estimated block trifocal tensor.

At step 230, the exemplary synchronization method generates camera matrices by concatenating the first four columns of the second factor matrices.

FIG. 2D shows an operational flow 200d of the exemplary synchronization method employed in a computer vision system. At step 202, the exemplary synchronization method receives a plurality of images acquired from a plurality of cameras, including a first camera and a second camera, each having an unspecified distance and orientation from one another.

At step 204, the exemplary synchronization method reconstructs, via a structure-from-motion computer vision application, a 3D world scene from the plurality of images (e.g., as an unordered set of 2D images).

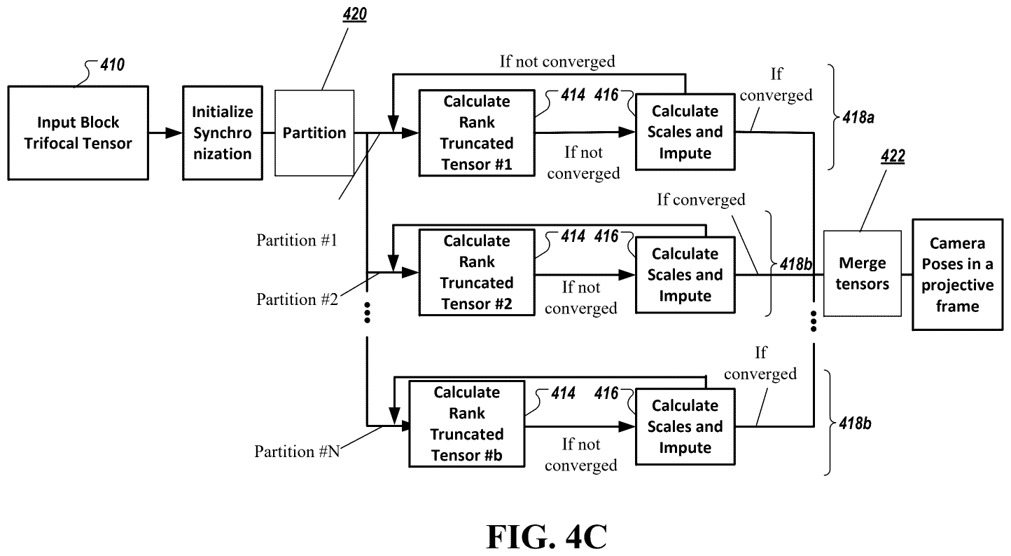

At step 232, the exemplary synchronization method determines, via a distributed synchronization operation, a global tensor estimate using triplewise or quadruplewise relative pose estimates. An example of the distributed operation is described in relation to FIG. 4C.

At step 208, the exemplary synchronization method outputs the global tensor estimate (e.g., corresponding camera pose, orientation) for visualization (e.g., in a photo tourism application) or control.

FIG. 2E shows an operational flow 200e of the exemplary synchronization method employed in a sensor system, which includes 4 steps. At step 202, the exemplary synchronization method receives data acquired from a plurality of sensors of a device (e.g., robot, controller of a vehicle), including a first sensor and a second sensor (e.g., camera, LIDAR, sonar; may have additional sensors such as GPS, IMU).

At step 204, the exemplary synchronization method estimates, via a SLAM application, sensor positions and a map from the received data.

At step 234, the exemplary synchronization method determines, via a distributed synchronization operation, a global tensor estimate using triplewise or quadruplewise relative pose estimates.

At step 208, the exemplary synchronization method outputs the global tensor estimate for control of the device (e.g., real-time control).

In some embodiments, the distributed synchronization operation in flows 200d and 200e includes distributing (e.g., via a partition module 122) the plurality of images among a set of computing resources (shown as 103a, 103b, . . . , 103n), where each computing resources (103a, 103b, . . . , 103n) is configured to perform a portion of the synchronization operation for a subset of the plurality of images to determine a subset of the triplewise or quadruplewise relative pose estimates. The subset of triplewise or quadruplewise relative pose estimates is then merged (e.g., via a merging module 124) for the subsets of the plurality of images.

In another embodiment, the operation may include (i) partitioning a dataset into k parts (e.g., randomly or algorithmically) so that each overlapping partition has at most a pre-defined number of cameras (e.g., 60 cameras), (ii) labeling the partitions and adding 2×k cameras from the (i+1)th partition into the ith partition, where the added cameras from the (i+1)th partition are a densest connected cameras to the ith partition, (iii) synchronizing each sub-dataset using the tensor synchronization algorithm, and (iv) computing a homography using the overlapping cameras and bringing all subproblems to a same projective, calibrated, or partially calibrated frame to achieve a large reconstruction.

In projective frames, images are not normalized, and cameras have unknown internal parameters prior to imaging. In calibrated frames, images are normalized, and cameras have all known internal parameters prior to imaging. In a partially calibrated frame, cameras have a subset of known internal parameters prior to imaging.

In some embodiments, the overlapping partitions have the same or different cameras, and the overlapping partitions have at least 10 indices or cameras in common.

### Example Block Trifocal or Quadrifocal Tensor Synchronization

A heuristic method may be employed for synchronizing the block trifocal or quadrifocal tensor \vec{T}ⁿ by exploiting the multilinear rank of Tⁿ from Theorem 1. Let \hat{T}ⁿ denotes the estimated block trifocal or quadrifocal tensor, and Tⁿ the ground truth. Assume that there are n images and a set of trifocal tensor estimates \hat{T}ᵢⱼₖ where a block position (e.g., (i,j,k)∈Ω for trifocal tensor), and Ω is the set of indices whose corresponding trifocal tensor is estimated. Each estimated trifocal tensor \hat{T}ᵢⱼₖ has an unknown scale (e.g., λᵢⱼₖ∈R*) associated with it. Similar analogous operations may be applied for quadrifocal tensor (e.g., (i,j,k,l)∈Ω for quadruplewise tensor \hat{T}ᵢⱼₖₗ).

Assume that the iii blocks (for trifocal sensors) are observed, as they are 0. An estimated block trifocal or quadrifocal tensor \hat{T}ⁿ is formulated by using the estimates (e.g., \hat{T}ᵢⱼₖ for trifocalt tensor) and setting the unobserved positions (e.g., (i,j,k)∉Ω) to 3×3×3 tensors of all zeros for trifocal tensor). For trifocal tensor, let W_{Ω}∈{0,1}^{3n×3n×3n} denote the block tensor where the (i,j,k) blocks are ones for (i,j,k)∈Ω and zeros otherwise. Let W_{Ω}_{^{c}} denote the block tensor where the (i,j,k) blocks are zeros for (i,j,k)∈Ω and ones otherwise. Similar analogous operations may be applied for quadrifocal tensor (e.g., W_{Ω}∈{0,1}^{3n×3n×3n×3n}).

The high-order singular value decomposition (HOSVD) is robust against noise for retrieving camera poses. Thus, an algorithm is developed to project the estimated block trifocal or quadrifocal tensor \hat{T}ⁿ onto the set of tensors that have multilinear ranks (e.g., (6,4,4) for trifocal tensor; (4, 4, 4, 4) for quadrifocal sensor), while completing the tensor and retrieving an appropriate set of scales is developed. Specifically, a projection problem may be defined per Equation 1:

$${min}_{Λ} {‖ Λ ⊙ {\hat{T}}^{n} - {P}_{τ} ( Λ ⊙ {\hat{T}}^{n} ) ‖}^{2} \qquad ( Eq . 1 )$$

In Equation 1, Λ∈R^{3n×3n×3n} (e.g., each 3×3×3 scale set A is uniform for trifocal tensor), Λᵢⱼₖ blocks are zero for (i,j,k)∉Ω, and A satisfies a normalization condition like ∥Λ∥²=1 to avoid its vanishing. However, this normalization constant is dropped in the implementation as Λ does not vanish in practice. Similar analogous operations may be applied for quadrifocal tensor for HOSVD (e.g., Λ∈R^{3n×3n×3n×3n}).

In the projection problem shown in Equation 1, P_{τ} denotes the exact projection onto the set Γ={T∈R^{3n×3n×3n}:mlrank(T)=(6,4,4)}, wherein mlrank(T) denotes the multilinear rank of a block trifocal tensor T. Although HOSVD provides an efficient way to project onto Γ, it is quasi-optimal and not the exact projection. The exact projection is harder to calculate and, in general, NP-hard. Similar analogous operations may be applied for quadrifocal tensor (e.g., Γ={T∈R^{3n×3n×3n}:mlrank(T)=(4,4,4,4)}).

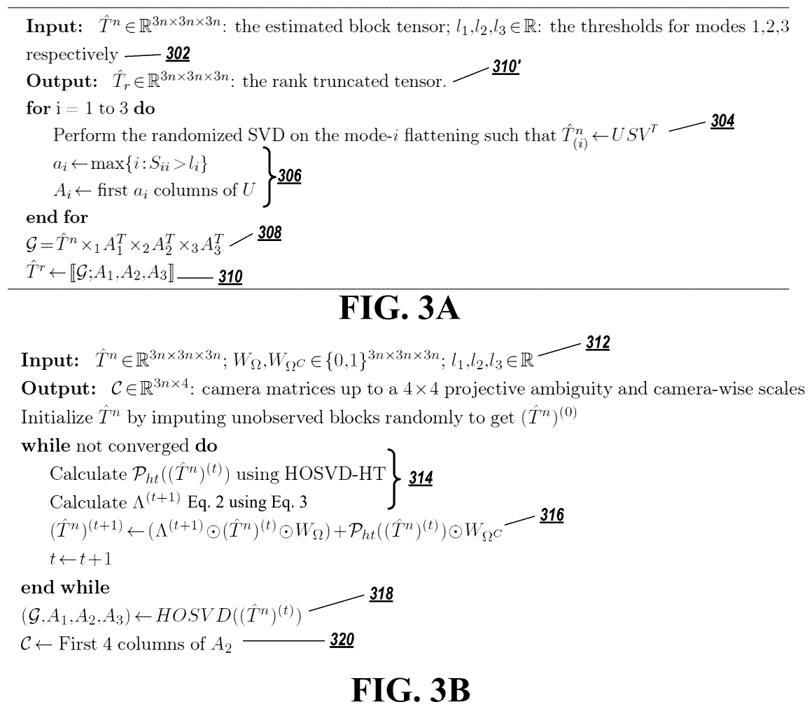

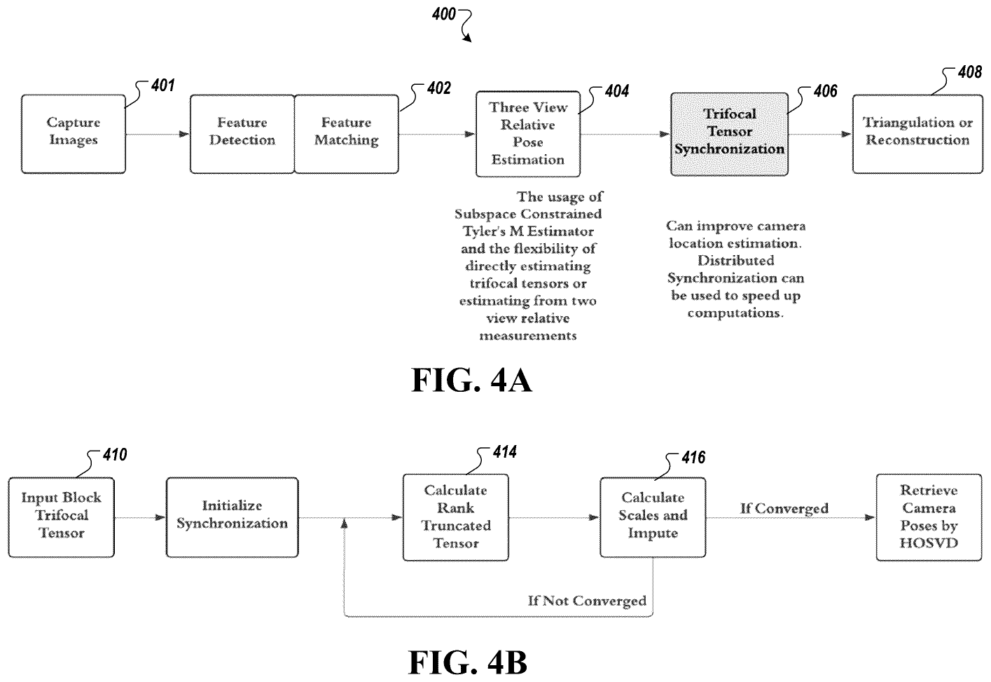

FIGS. 3A-3B shows an example algorithmic implementation for the exemplary synchronization method employed in the triplewise or quadruplewise camera/sensor pose estimator shown in FIGS. 1A-1C. FIG. 4B shows an example implementation of the algorithm of FIG. 3A and FIG. 3B. The implementation adopts the matrix completion idea of HARD-IMPUTE [35], where a camera matrix (i.e., camera/sensor global tensor estimate) is generated from the pose estimator by iteratively filling in the estimated trifocal or quadrifocal block tensor (e.g., combined images and camera positions, combined sensor data and sensor positions) produced from the SLAM module with a rank truncated matrix obtained from a hard-thresholded singular value decomposition (SVD). The missing blocks in the estimated trifocal or quadrifocal block tensor are completed with the corresponding blocks in the rank truncated tensor.

Higher-order singular value decomposition with a hard threshold (HOSVD-HT). FIG. 3A shows an example algorithm 300a (also referred to as the HOSVD algorithm) generating the rank-truncated matrix using relative scales on the rank-truncated tensor as a heuristic to retrieve scales for the estimated block tensor.

As shown in FIG. 3A, at line 302 (e.g., 410 of FIG. 4B), the algorithm 300a takes a plurality of inputs, including the estimated trifocal block tensor \hat{T}ⁿ and three hyperparameters l₁, l₂, l₃ are defined corresponding to the thresholding parameters of the hard-thresholded SVD on modes 1, 2, 3 of the block tensor, respectively. The output of the algorithm 300a is a rank-truncated tensor \hat{T}ⁿ, referred to as 310 and 310′. Similar analogous operations may be applied for quadrifocal tensor (e.g., estimated quadrifocal block tensor \hat{T}ⁿ with four hyperparameters l₁, l₂, l₃, l₄).

At line 304, for each mode-i (e.g., i=1, 2, 3), flattening

$${T}_{( i )}^{n} ,$$

the algorithm 300a calculates the full SVD as

$${T}_{( i )}^{n} = {USV}^{T}$$

using a randomized SVD since the tensor will scale cubically with the number of cameras, wherein U denotes an orthonormal matrix and S denotes a line matrix.

Assume the singular values σᵢ on the diagonal of S are sorted in descending order, at lines 306, the algorithm 300a returns the factor matrix Aᵢ as the top a left singular vector in the orthonormal matrix U, where a=max{i: Sᵢᵢ>lᵢ}, i.e., a is the maximum value of i wherein value at the index ii of the line matrix S, denoted as Sᵢᵢ, is larger than the parameter l at index i, denoted as lᵢ.

At line 308, the algorithm 300a generates a core tensor G by cross-multiplying the estimated block trifocal tensor \hat{T}ⁿ and the transposes of the factor matrices

$$( e . g . {A}_{1}^{T} , {A}_{2}^{T} , {A}_{3}^{T} ) .$$

Similar analogous operations may be applied for quadrifocal tensor

$$( e . g . {A}_{1}^{T} , {A}_{2}^{T} , {A}_{3}^{T} , {A}_{4}^{T} ) .$$

At line 310 (e.g., 414 of FIG. 4B), the algorithm 300a generates and outputs a rank-truncated tensor \hat{T}^{r} by concatenating the factor matrices (e.g., A₁, A₂, A₃) and the core tensor G. Similar analogous operations may be applied for quadrifocal tensor.

Scale recovery and Synchronization. FIG. 3B shows an example algorithm 300b for synchronizing the block trifocal tensor using block scale recovery. At line 312, the algorithm 300b takes a plurality of inputs, including \hat{T}ⁿ, W_{Ω}, W_{Ω}_{^{c}}, and the thresholds l₁, l₂, l₃ for modes 1, 2, 3. The outputs of the algorithm 300b are the camera matrices (i.e., camera/sensor global tensor estimate), referred to as 320 and 320′. Similar analogous operations may be applied for quadrifocal tensor (e.g., thresholds l₁, l₂, l₃, l₄ for modes 1, 2, 3, 4).

HOSVD-HT provides an efficient projection \hat{T}ⁿ onto the set of tensors with multilinear rank (e.g., (6,4,4) for trifocal tensor; (4,4,4,4) for quadrifocal tensor). To recover scales, at lines 314 (e.g., 416, FIG. 4B), the algorithm 300b uses the rank truncated tensor's relative scale as a heuristic to adjust the scale on the estimated block trifocal tensor \hat{T}ⁿ. For each step t, an initial block scale is calculated per Equation 2.

$${Λ}^{( t + 1 )} = {arg min}_{Λ} {‖ Λ ⊙ {\hat{T}}^{n} - {P}_{ht} ( {Λ}^{( t )} ⊙ {\hat{T}}^{n} ) ‖}^{2} \qquad ( Eq . 2 )$$

In Equation 2, the normalization condition on A is dropped because, in implementation, it is not needed. Equation 2 determines the initial scale for each observed block separately. Denoting Pₕₜ(Λ^{(t)}⊙\hat{T}ⁿ) as

$${( {\hat{T}}_{r}^{n} )}^{( t )} ,$$

at each step t, the initial block scale is adjusted per Equation 3 (shown for trifocal sensor; similar analogous operations may be applied for quadrifocal tensor).

$${Λ}^{( t + 1 )} = {arg min}_{μ} {‖ μ \cdot {\hat{T}}_{ijk}^{n} - {( {\hat{T}}_{r}^{n} )}_{ijk}^{( t )} ‖}^{2} = \frac{trace ( {( {\hat{T}}_{ijk}^{n} )}_{( 1 )}^{T} {( {( {\hat{T}}_{r}^{n} )}_{ijk}^{( t )} )}_{( 1 )} )}{{‖ {( {( {\hat{T}}_{r}^{n} )}_{ijk}^{( t )} )}_{( 1 )} ‖}_{F}^{2}} \qquad ( Eq . 3 )$$

The strategy for completing the tensor is to impute the tensor with the entries from the rank-truncated tensor using HOSVD-HT. Specifically, at line 316, the algorithm 300b updates the imputed tensor (\hat{T}ⁿ)^{(t)} as shown in Equation 4 using Pₕₜ((\hat{T}ⁿ)^{(t)}) and the new scales Λ^{(t+1)} calculated at lines 314.

$${( {\hat{T}}^{n} )}^{( t + 1 )} = ( {Λ}^{( t + 1 )} ⊙ {( {\hat{T}}^{n} )}^{( t )} ⊙ {W}_{Ω} ) + {P}_{ht} ( {( {\hat{T}}^{n} )}^{( t )} ) ⊙ {W}_{Ω} c \qquad ( Eq . 4 )$$

The algorithm 300b may overfit, as the recovered scales experience sudden and huge leaps. The stopping criteria for the algorithm 300b may include (i) when sudden jumps in the variance of the new scales are determined or (ii) the maximum number of iterations is exceeded.

At line 318, the algorithm 300b generates factor matrices (e.g., A₁, A₂, and A₃ for trifocal sensor; similar analogous operations may be applied for quadrifocal tensor) and a core tensor G from the estimated trifocal or quadrifocal block tensor \hat{T}ⁿ using the HOSVD algorithm 300a.

At line 320, the algorithm 300b generates and outputs the camera matrices C (i.e., camera/sensor global tensor estimate) by concatenating the first four columns of the second-factor matrices A₂ (for trifocal tensor; similar analogous operations may be applied for quadrifocal tensor).

The algorithms 300a and 300b solve the challenges for calculating the rank truncated sensor: (1) the exact projection P_{τ} onto Γ is expensive and difficult to calculate, and (2) many blocks in the block tensor are unknown when the corresponding images of the block lack a corresponding point, and directly projecting the uncompleted tensor is inaccurate. This is because the algorithms use a simple, efficient, and quasi-optimal HOSVD to project onto Γ, and the algorithms complete the estimated trifocal or quadrifocal block tensor \hat{T}ⁿ.

Another challenge in the structure of motion datasets is that estimations may be corrupted. The HOSVD algorithm 300a consists of retrieving a dominant subspace from each flattening. Thus, it is natural to replace the SVD on each flattening with a more robust subspace recovery method, such as Tyler's M estimator (TME) [37] or a recent extension of TME that incorporates the information on the dimension of the subspace in the algorithm [38].

### Example Trifocal or Quadruplewise Block Tensor

Cameras and three-dimensional (3D) geometry. Given a collection of n images I₁, . . . , Iₙ of a 3D scene, let tᵢ∈R³ and Rᵢ∈SO(3) denote the location and orientation of the camera associated with the image Iᵢ in the global coordinate system SO(3) (i.e., a group of all possible rotations of an object in 3D Euclidean space). Moreover, each camera is associated with a calibration matrix Kᵢ that encodes the intrinsic parameters of a camera, including the focal length, the principal points, and the skew parameter. Then, the 3×4 camera matrix has the following form, Pᵢ=KᵢRᵢ[I_{3×3},−tᵢ], and is defined up to a nonzero scale. 3D world points X are represented as R⁴ vectors in homogeneous coordinates, and the projection of X onto the image corresponding to P is x=PX.

3D world lines L may be represented via Plücker coordinates as an R⁶ vector. Then, the projection of L onto the image corresponding to P is l=PL, where P is the 3×6 line projection matrix. It may be written as P=[P²∧P³; P³∧P^{I}; P¹∧P²] where Pⁱ is the i-th row of the camera matrix P, and the wedge denotes exterior product. Explicitly, the (i,j) element of the line projection matrix may be calculated as the determinant of the submatrix, where the i-th row is omitted, and the columns are selected as the j-th pair from [(1,2),(1,3),(1,4),(2,3),(2,4),(3,4)]. The elements on the second row are multiplied by −1.

To retrieve global poses, relative measurement of pairs or triplets of images is needed. Let xᵢ and xⱼ be any pair of corresponding keypoints in images Iᵢ and Iⱼ, respectively, meaning that they are images of a common world point. The fundamental matrix Fᵢⱼ is a 3×3 matrix such that

$${x}_{i}^{T} {F}_{ij} {x}_{j} = 0 ,$$

wherein Fᵢⱼ encodes the relative orientation

$${R}_{ij} = {R}_{i} {R}_{j}^{T}$$

and translation tᵢⱼ=Rᵢ(tᵢ−tⱼ) through

$${F}_{ij} = {K}_{i}^{- T} [ {t}_{ij} ] \times {R}_{ij} {K}_{j}^{- 1} .$$

The essential matrix corresponds to the calibrated case, where Kᵢ=I_{3×3} for all i.

Trifocal and Quadrifocal tensors. Analogous to the fundamental matrix, the trifocal tensor Tᵢⱼₖ is a 3×3×3 tensor that relates the features across images and characterizes the relative pose between a triplet of cameras Pᵢ, Pⱼ, Pₖ. The trifocal tensor Tᵢⱼₖ corresponding to cameras Pᵢ, Pⱼ, Pₖ may be calculated by Equation 5. Similar analogous operations may be applied for quadrifocal tensor (e.g., Tᵢⱼₖₗ for a 3×3×3×3 tensor having quadruplet of cameras Pᵢ, Pⱼ, Pₖ, Pₖ, Pₗ).

$${( {T}_{ijk} )}_{wqr} = {( - 1 )}^{w + 1} det [ \begin{matrix}\sim {P}_{i}^{w} \\ {P}_{j}^{q} \\ {P}_{k}^{r}\end{matrix} ] \qquad ( Eq . 5 )$$

In Equation 5,

$${P}_{i}^{w}$$

is the w-th row of Pᵢ, and ˜

$${P}_{i}^{w}$$

is the 2×4 submatrix of Pᵢ, omitting the w-th row. The trifocal tensor and quadrifocal tensor determine the geometry of three or four cameras, respectively, up to a global projective ambiguity or up to a scaled rigid transformation in the calibrated case. In addition to point correspondences, trifocal tensors and quadrifocal tensors satisfy constraints for corresponding lines and mixtures thereof. For example, for trifocal tensor, let lᵢ, lⱼ, lₖ be corresponding image lines in the views of cameras Pᵢ, Pⱼ, Pₖ, respectively, then the lines are related through the trifocal tensor Tᵢⱼₖ by

$${( {l}_{j}^{T} [ {( {T}_{ijk} )}_{1 \text{::}} , {( {T}_{ijk} )}_{2 \text{::}} , {( {T}_{ijk} )}_{3 \text{::}} ] {l}_{k} ) [ l ]}_{x} ,$$

where [l]ₓ denotes the ×3 skew-symmetric matrix corresponding to the cross product by l. Similar analogous operations may be applied for quadrifocal tensor (e.g., cameras Pᵢ, Pⱼ, Pₖ, Pₗ to generate quadrifocal tensor Tᵢⱼₖₗ, expressed as

$${( {l}_{j}^{T} [ {( {T}_{ijk} )}_{1 \text{::}} , {( {T}_{ijk} )}_{2 \text{::}} , {( {T}_{ijk} )}_{3 \text{::}} , {( {T}_{ijk} )}_{4 \text{::}} ] {l}_{k} ) [ l ]}_{x} .$$

Since corresponding lines put constraints on the trifocal or quadrifocal tensor, one advantage of incorporating trifocal or quadrifocal tensors into the structure from motion pipelines is that trifocal or quadrifocal tensors may be estimated purely from line correspondences or a mixture of points and lines. Fundamental matrices may not be estimated directly from line correspondences, so the effectiveness of pairwise methods for datasets where feature points are scarce is limited, as shown in previous studies [24]-[31]. Furthermore, trifocal or quadrifocal tensors have the potential to improve location estimation. From pairwise measurements, the location estimation in the pairwise setting is a challenge [32]. However, trifocal or quadrifocal tensors encode the relative scales of the direction and may simplify the location estimation procedure.

Let T∈R^{I}^{₁}^{×I}^{₂}^{× . . . ×I}^{_{N}} be an order N^{th} tensor. The mode-i flattening (or matrixization) T₍ᵢ₎∈R^{I}^{ᵢ}^{×I}^{₁}^{. . . (I}^{_{i−1}}^{I}^{ᵢ₊₁} ^{. . . I}^{_{N}}⁾ is the rearrangement of Tinto a matrix by taking mode-i fibers to be columns of the flattened matrix. By convention, the ordering of the columns in the flattening follows the lexicographic order of the modes, excluding i. Symbols ⊗ and ⊙ denote the Kronecker product and the Hadamard product, respectively. The norm on tensors is defined as ∥T∥=∥T₍₁₎∥_{F}. The i-rank of Tis the column rank of T₍ᵢ₎ and is denoted as rankᵢ(T). Let Rᵢ=rankᵢ(T), then the multilinear rank of Tis defined as mlrank(T)=(R₁, R₂, . . . , R_{N}). The i-mode product of T with a matrix U∈R^{m×I}^{ᵢ} is a tensor in R^{I}^{₁}^{× . . . ×I}^{_{i−1}}^{×m×I}^{ᵢ₊₁}^{× . . . ×I}^{_{N}} defined in Equation 6.

$${( T {\times }_{i} U )}_{{j}_{1} … {j}_{i - 1} {kj}_{i + 1} ... {j}_{N}} = {{\sum }_{{j}_{i} = 1}}^{{I}_{i}} {T}_{{j}_{1} {j}_{2} .. {j}_{N}} {U}_{{kj}_{i}} \qquad ( Eq . 6 )$$

Then, the Tucker decomposition of T∈R^{I}^{₁}^{×I}^{₂}^{× . . . ×I}^{_{N}} is a decomposition, e.g., per Equation 7.

$$T = G {\times }_{1} {A}_{1} {\times }_{2} {A}_{2} {\times }_{3} … {\times }_{N} {A}_{N} = [ G ; {A}_{1} , {A}_{2} , … , {A}_{N} ] \qquad ( Eq . 7 )$$

In Equation 7, G∈R^{Q}^{₁}^{×Q}^{₂}^{× . . . ×Q}^{_{N}} is the core tensor, and Aₙ∈R^{I}^{ₙ}^{λQ}^{ₙ} are the factor matrices. Without loss of generality, the factor matrices are assumed to have orthonormal columns. Given the multilinear rank of the core tensor (R₁, . . . , R_{N}), the Tucker decomposition approximation problem may be determined per Equation 8.

$${arg min}_{G ∈ {R}^{{R}_{1} \times {R}_{2} \times … \times {R}_{N} ,} {A}_{i} ∈ {R}^{{I}_{i} \times {R}_{i}}} ‖ T - [ G ; {A}_{1} , {A}_{2} , … , {A}_{N} ] ‖ \qquad ( Eq . 8 )$$

A way of solving Equation 8 is the higher-order singular value decomposition (HOSVD). The HOSVD is computed with the following steps. First, for each i, calculate the factor matrix Aᵢ as the Rᵢ leading left singular vectors of T₍ᵢ₎. Second, set the core tensor G as

$$G = T {\times }_{1} {A}_{1}^{T} {\times }_{2} … {\times }_{N} {A}_{N}^{T} .$$

Though the solution from HOSVD will not be the optimal solution to Equation 4, it enjoys a quasi-optimality property: when T* is the optimal solution, and T′ is the solution from HOSVD, then Equation 9 occurs.

$$‖ T - {T}^{*} ‖ \leq \sqrt{N} ‖ T - {T}^{′} ‖ \qquad ( Eq . 9 )$$

Low Tucker rank of the block trifocal tensor and one-shot camera retrieval. Assume there is a set of camera matrices

$${\{ {P}_{i} \}}_{i = 1}^{n}$$

with n≥3 and scales fixed on each camera matrix. Define the block trifocal tensor Tⁿ to be the 3n×3n×3n tensor, where the 3×3×3-sized ijk block is the trifocal tensor corresponding to the triplet of cameras Pᵢ, Pⱼ, Pₖ. Assume for all blocks that have overlapping indices, the corresponding 3×3×3 tensor is also calculated using the formula Equation 5. Similar analogous operations may be applied for quadrifocal tensor.

Table 1 and Theorem 1 show the properties of the block trifocal tensor Tⁿ for all distinct indices i,j∈[n]. Similar analogous operations may be applied for quadrifocal tensor.

TABLE 1

| Property | Description |
|---|---|
| (i) | ${T}_{iii}^{n} = {0}_{3 \times 3 \times 3} .$ |
| (ii) | $The {T}_{iii}^{n} blocks are rearrangements of elements in the fundamental maxtrix {F}_{ij} up$ |
| | to signs. |
| (iii) | The horizontal slices Tⁿ(i,:,:) of Tⁿ are skew-symmetric. |
| (iv) | $Three singular values of {T}_{( 1 )}^{n} are equal when all cameras are calibrated .$ |

Theorem 1 (Example Tucker factorization and low multilinear rank of block trifocal tensor). The block trifocal tensor Tⁿ admits a Tucker factorization, Tⁿ=G×₁P×₂C×₃C, where G∈R^{6×6×4}, P∈R^{3n×6}, and C∈R^{3n×4}. When the n cameras that produce Tⁿ are not all collinear, then the multilinear rank of Tⁿ is defined as mlrank(Tⁿ)=(6,4,4) (for trifocal tensor; (4, 4, 4, 4) for quadrifocal tensor). When the n cameras that produce Tⁿ are collinear, then the multilinear rank of Tⁿ is defined as mlrank(P)≤(6,4,4) (for trifocal tensor; Tⁿ is defined as mlrank(Tⁿ)≤(4,4,4,4) for quadrifocal tensor).

Mathematical Proof One example proof is provided for trifocal tensor; similar analogous operations may be applied for quadrifocal tensor. The Tucker factorization, Tⁿ=G×₁P×₂C×₃C, may be explicitly calculated. The horizontal slices of the core tensor T are:

$$\{ [ \begin{matrix}0 & 0 & 0 & 0 \\ 0 & 0 & 0 & 0 \\ 0 & 0 & 0 & 1 \\ 0 & 0 & - 1 & 0\end{matrix} ] , [ \begin{matrix}0 & 0 & 0 & 0 \\ 0 & 0 & 0 & - 1 \\ 0 & 0 & 0 & 1 \\ 0 & 1 & 0 & 0\end{matrix} ] , [ \begin{matrix}0 & 0 & 0 & 0 \\ 0 & 0 & 1 & 0 \\ 0 & - 1 & 0 & 0 \\ 0 & 0 & 0 & 0\end{matrix} ] , [ \begin{matrix}0 & 0 & 0 & 1 \\ 0 & 0 & 0 & 0 \\ 0 & 0 & 0 & 0 \\ - 1 & 0 & 0 & 0\end{matrix} ] , [ \begin{matrix}0 & 0 & - 1 & 0 \\ 0 & 0 & 0 & 0 \\ 1 & 0 & 0 & 0 \\ 0 & 0 & 0 & 0\end{matrix} ] , [ \begin{matrix}0 & 1 & 0 & 0 \\ - 1 & 0 & 0 & 0 \\ 0 & 0 & 0 & 1 \\ 0 & 0 & 0 & 0\end{matrix} ] \}$$

The factor matrices are C=[P₁, P₂, . . . , Pₙ]^{T}∈R^{3n×4} and P=[S₁, S₂, . . . , Sₙ]^{T}∈R^{3n×6}, where Pᵢ are the camera matrices, and Sᵢ are the corresponding line projection matrices.

Assume n cameras are not collinear, then C and P both have full rank. From [1], the null space of a camera matrix Pᵢ is generated by the camera center. Suppose that rank(C)<4, then there exists x∈R⁴ such that x≠0 and Cx=0. This means that Pᵢx=0 for all i=1, . . . , n. Then, x is the camera center for all cameras, which means that the cameras are centered at one point and are collinear, contradicting the assumption. Similarly, every vector in the null space of the line projection matrix Sᵢ is a line that passes through the camera center [1]. Suppose that rank(P)<6. Then, there exists x∈R⁶ such that x≠0 and Px=0. This implies that Sᵢx=0 for all i=1, . . . , n, which means that x is a line that passes through all of the camera centers. Again, the cameras are collinear, which is a contradiction to the assumption.

Next, the flattening of the block trifocal tensor is defined as

$${T}_{( 1 )}^{n} = {{PG}_{( 1 )} ( C ⊗ C )}^{T} .$$

Then P∈R^{3n×6} has rank 6, and (C⊗C)^{T}∈R^{16×9n}^{²} has rank 16. Given the specific form of G, where G₍₁₎∈R^{6×16}, then rank(G₍₁₎)=6. Thus, rank

$$( {T}_{( 1 )}^{n} ) = 6.$$

### Similarly,

$$rank ( {T}_{( 2 )}^{n} ) = 4 , and rank ( {T}_{( 3 )}^{n} ) = 4.$$

This implies that the multilinear rank of the block trifocal tensor is (6,4,4) when the n cameras are not collinear.

When the n cameras are collinear, the individual factors in each flattening may be rank deficient, so that

$$rank ( {T}_{( 1 )}^{n} ) \leq 6 , rank ( {T}_{( 2 )}^{n} ) \leq 4 , rank ( {T}_{( 3 )}^{n} ) \leq 4.$$

This implies mlrank(Tⁿ)≤(6,4,4).

Proposition 2 (Example one-shot camera pose retrieval). Given the block trifocal or quadrifocal tensor Tⁿ produced by cameras P₁, P₂, . . . , Pₙ, the cameras may be retrieved from Tⁿ up to a global projective ambiguity using the higher-order SVD. The cameras will be the leading 4 singular vectors of

$${T}_{( 2 )}^{n} or {T}_{( 3 )}^{n} .$$

Using the higher-order SVD on Tⁿ, a Tucker decomposition of the block trifocal tensor Tⁿ=Ĝ×₁\hat{P}×₂Ĉ×₃Ĉ′ may be retrieved. Similar analogous operations may be applied for quadrifocal tensor. Though the Tucker factorization is not unique [33], as an invertible linear transformation may be applied to one of the factor matrices and the inverse may be applied to the core tensor, this invertible linear transformation may be the inevitable global projective ambiguity of all 3D reconstruction algorithms. Thus, the cameras are the leading four singular vectors of the mode-2 and mode-3 flattenings of the block tensor.

In practice, each trifocal or quadrifocal tensor block in Tⁿ may be estimated from image data only up to an unknown multiplicative scale [1]. The following theorem establishes the fact that the multi-linear rank constraints provide sufficient information for determining the correct scales. In the statement, ⊙_{b} denotes blockwise scalar multiplication; thus, the (i,j,k)-block of λ⊙_{b}Tₙ is

$${λ}_{ijk} {T}_{ijk}^{n} ∈ {R}^{3 \times 3 \times 3} .$$

Similar analogous operations may be applied for quadrifocal tensor (e.g., (i,j,k,l)-block)

Theorem 2. Let Tⁿ∈R^{3n×3n×3n} be a block trifocal tensor corresponding to n≥4 calibrated or uncalibrated cameras in a generic position. Let λ∈R^{n×n×n} be a block scaling with λᵢⱼₖ nonzero if and only if i, j, k are not all equal. Assume that λ⊙Tⁿ∈R^{3n×3n×3n} has a multilinear rank (6,4,4) where Ob denotes blockwise scalar multiplication, then there exist α,β,γ∈Rⁿ such that λᵢⱼₖ=αᵢβⱼγₖ whenever i, j, k are not all the same. Similar analogous operations may be applied for quadrifocal tensor (e.g., Tⁿ∈R^{3n×3n×3n×3n}; λ∈R^{n×n×n}; λ⊙_{b}Tⁿ∈R^{3n×3n×3n×3n} has a multilinear rank (4,4,4,4)).

Theorem 2 is the basic guarantee for the algorithm development of the exemplary synchronization method. The ambiguities brought by α,β,γ are not problematic for the purposes of recovering the camera matrices by Proposition 2. Indeed, (α⊗β⊗γ)⊙_{b}Tⁿ=G×₁(D_{α}P)×₂(D_{β}C)×₃(D_{γ}C) where D_{α}∈R^{3n×3n} is the diagonal matrix with each entry of a triplicated, etc. Hence, the camera matrices may still be recovered up to individual scales and a global projective transformation, from the higher-order SVD.

### Example Applications

FIGS. 4A and 4B each show an example application utilizing the tensor-based synchronization system and method in accordance with an illustrative embodiment.

FIG. 4A shows a motion pipeline 400 employing a trifocal or quadrifocal tensor-based structure. In the example shown in FIG. 4A, the motion pipeline 400 includes a feature detection and feature matching module 402, a pose estimation module 404 (i.e., pose estimator 404), a trifocal tensor synchronization module 406, and a triangulation or reconstruction module 408. The feature detection and feature matching module 402 receives a set of captured images 401 and performs feature detection and feature matching, e.g., as described in relation to [41]. In the operation, the module 402 may match two or more images using SIFT features. Module 402 may reject outlier matches using an estimated fundamental matrix, e.g., using random sample consensus (RANSAC). The module 402 may further screen the two or more matches using Feature Correspondence Check (FCC) [42].

The pose estimator 404 is configured to receive a triplet or quadruplet match and calculate trifocal or quadrifocal tensors, e.g., as described in relation to FIGS. 3A and 3B. The pose estimator 404 may use subspace-constrained Tyler's M estimator. In one embodiment, the pose estimator 404 is configured to flexibly and directly estimate the trifocal or quadrifocal tensors. In another embodiment, the pose estimator 404 is configured to perform estimation from two-view relative measurements. In some embodiments, to have an even sparser graph and speed up the operation, module 404 may skip the estimation of trifocal or quadrifocal tensors and rely on the imputation for images that have less than a number bigger than 11-point correspondences.

The trifocal or quadrifocal tensor synchronization module 406 is configured to synchronize the estimated block trifocal or quadrifocal tensor. The module 406 may employ SVD-based operation, e.g., the robust subspace recovery operation [38].

The module 406 may improve camera location estimation. Distributed synchronization can be used to speed up computations. An example of distributed synchronization for a photo tourism application.

### Example Distributed Synchronization

Tensor computations may be more expensive than matrix computations, so the tensor synchronization algorithm is slower than the two-view methods. However, the synchronization problem can be solved in parallel, and the exemplary tensor-based system and method can be accelerated using parallelization.

Specifically, a distributed synchronization operation is developed for the exemplary method comprising four steps: (i) partitioning the dataset randomly into k parts, so that each partition has roughly 60 cameras, (ii) labeling the partitions and add (2×k) cameras from the (i+1)th partition into the ith partition, where the added cameras from the (i+1)th partition are densest connected cameras to the ith partition, (iii) synchronizing each sub dataset using the tensor synchronization algorithm, and (iv) computing a homography using the overlapping cameras and bring all subproblems to the same projective frame to achieve a large reconstruction. In some embodiments, the distributed synchronization operation partitions (step (i)) a viewing graph using hMETIS [45], a hypergraph partitioning package.

FIG. 4C shows an example distributed synchronization operation. In FIG. 4C, the same operation performed in FIG. 4B (shown as 418a, 418b, . . . , 418n) is performed across multiple computing resources (e.g., multiple computers). The operation includes distributing (e.g., partition 420) the plurality of images among a set of computing resources (shown as 103a, 103b, . . . , 103n), where each computing resources (103a, 103b, . . . , 103n) is configured to perform a portion of the synchronization operation for a subset of the plurality of images to determine a subset of the triplewise or quadruplewise relative pose estimates. The subset of triplewise or quadruplewise relative pose estimates is then merged (422) for the subsets of the plurality of images.

### Example Alternating Direction Method of Multipliers (ADMM) Algorithm

The operation of the block trifocal or quadrifocal tensor optimization operation described above may be improved by providing sufficient density of the viewing graph, or in other words, the completion rate of the block trifocal or quadrifocal tensor should not be low. An alternative optimization operation is developed to handle sparser graphs, extending from the previous study [46] to the higher-order scenario. The optimization operation may select a cover of the 4-uniform hypergraph on the set of cameras, and enforce consistency of the trifocal or quadrifocal tensors within each hyperedge through a low Tucker rank tensor constraint on collections of trifocal or quadrifocal tensors. The optimization operation may use the Alternating Direction Method of Multipliers (ADMM) with tractably solvable subproblems. The ADMM algorithm may require tuning of the hyperparameters and an initialization. The ADMM algorithm may be employed for cases where the block trifocal or quadrifocal tensor optimization operation fails. The formation of the ADMM algorithm is described in detail below.

Constructing Quadruplet Cover via Cycle Consistency. Assuming a quadrifocal graph G_{T}=(V,E) is constructed, where e∈E if two quadruplets share at least two common cameras, and v E V represents a quadruplet of cameras which all permutations of the camera indices have a trifocal tensor estimated, such as (1, 2, 3, 4), (5, 10, 22, 54), etc. Each node is associated with an inconsistency measure, determining how clean this node is. Given a trifocal tensor Tᵢⱼₖ, cameras Pᵢ, Pⱼ, Pₖ that make up Tᵢⱼₖ up to a projective transformation can be determined. Since 2 cameras can fix a projective frame, the cycles shown in Equation 10 can be formed for nodes i, j, k, and l.

$${T}_{ijk} \to {T}_{jkl} \to {T}_{kli} \to {T}_{lij} \qquad ( Eq . 10 )$$

In Equation 10, a projective transformation that brings the cameras to the same frame can be calculated for each arrow. A final inconsistency measure can be d((Pᵢ, Pⱼ),

$$( {P}_{i}^{′} , {P}_{j}^{′} ) )$$

with respect to some metric d between pairs of camera matrices, such as mean rotation differences or mean translation differences.

Given a viewing graph G=(V,E), a trifocal or quadrifocal viewing graph Gτ=(V_{τ}, E_{τ}) can be formed, where V_{τ} is the set of triplets where a trifocal tensor is measured (and quadruplets for quadrifocal tensor), and e∈E_{τ} if the two triplets share two cameras (e.g., two quadruplets for quadrifocal tensor). Then, 4 cycles ijk, jkl, kli, lij in this graph can be found, and the cycle inconsistencies can be measured to find good quadruplets. After knowing good quadruplets, another quadrifocal viewing graph G, can be formed, and a quadruplet cover of good quadruplets of cameras can be found. A greedy algorithm can be employed by starting from a quadruplet with the lowest inconsistency measure and continuing to add quadruplets until all cameras are included in at least one quadruplet, and each quadruplet overlaps in at least two camera indices with another quadruplet.

Optimization. After finding a quadruplet cover, the optimization problem in Equation 11 can be solved.

$${min}_{T , Λ} {{\sum }_{k = 1}}^{m} {‖ {\hat{T}}_{τ ( k )} - {Λ}_{τ ( k )} ⊙ {T}_{τ ( k )} ‖}_{F}^{2} + λ {‖ {Λ}_{τ ( k )} ‖}_{F}^{2} \qquad ( Eq . 11 )$$

$$s . t . T ( i , ∶ , ∶ ) = - {T ( i , ∶ , ∶ )}^{T}$$

$${T}_{iii} = {0}_{3 \times 3 \times 3}$$

$$mlrank ( {T}_{τ ( k )} ) = ( 6 , 4 , 4 )$$

For an ADMM approach, auxiliary variables and Lagrange multipliers can be introduced into Equation 11, giving an objective function defined per Equation 12.

$${max}_{Γ} {min}_{T , Λ} {{\sum }_{k = 1}}^{m} α {‖ {\hat{T}}_{τ ( k )} - {Λ}_{τ ( k )} ⊙ {T}_{τ ( k )} ‖}_{F}^{2} + αλ {‖ {Λ}_{τ ( k )} ‖}_{F}^{2} + {‖ {B}_{k} - {T}_{τ ( k )} + {Γ}_{k} ‖}_{F}^{2} \qquad ( Eq . 12 )$$

$$s . t . T ( i , ∶ , ∶ ) = - {T ( i , ∶ , ∶ )}^{T}$$

$${T}_{iii} = {0}_{3 \times 3 \times 3}$$

$$mlrank ( {B}_{k} ) = ( 6 , 4 , 4 )$$

Then, the variables T, Λ, and B can be updated as described herein. Specifically, to update T and Λ, the subproblem that should be solved is Equation 13.

$${min}_{T , Λ} {{\sum }_{k = 1}}^{m} α {‖ {\hat{T}}_{τ ( k )} - {Λ}_{τ ( k )} ⊙ {T}_{τ ( k )} ‖}_{F}^{2} + αλ {‖ {Λ}_{τ ( k )} ‖}_{F}^{2} + {‖ {B}_{k} - {T}_{τ ( k )} + {Γ}_{k} ‖}_{F}^{2} \qquad ( Eq . 13 )$$

$$s . t . T ( i , ∶ , ∶ ) = - {T ( i , ∶ , ∶ )}^{T}$$

$${T}_{iii} = {0}_{3 \times 3 \times 3}$$

Equation 13 can be solved by alternatingly minimizing over T, A until the subproblem converges. Symmetry can be explicitly maintained. Let Nᵢⱼₖ be the number of edges that contain Tᵢⱼₖ. Then, the update rule for each block (i,j,k) such that j<k (i.e., update rule for T) can be defined per Equation 14.

$${T ( i , j , k )}^{( t )} = \frac{\begin{matrix}{\sum }_{s = 1}^{{N}_{ijk}} {B}_{s}^{( t - 1 )} ( i , j , k ) + {Γ}_{s}^{( t - 1 )} ( i , j , k ) + \\ {αΛ}_{τ ( s )}^{( t - 1 )} ( i , j , k ) {\hat{T}}_{τ ( s )} ( i , j , k )\end{matrix}}{{\sum }_{s = 1}^{{N}_{ijk}} α {( {Λ}_{τ ( s )}^{( t - 1 )} ( i , j , k ) )}^{2} + 1} \qquad ( Eq . 14 )$$

Within each quadruplet, A for each block can be solved, where the update rule for A can be defined per Equation 15.

$${{Λ}_{τ ( s )} ( i , j , k )}^{( t )} = \frac{tr ( {{\hat{T}}_{τ ( s )} ( i , j , k )}^{T} {T}_{τ ( s )}^{( t )} ( i , j , k ) )}{{‖ {\hat{T}}_{τ ( s )}^{( t )} ( i , j , k ) ‖}_{F}^{2} + λ} \qquad ( Eq . 15 )$$

To update B, the subproblem in Equation 16 should be solved.

$${min}_{B} {{\sum }_{k = 1}}^{m} {‖ {B}_{k} - {T}_{τ ( k )} + {Γ}_{k} ‖}_{F}^{2} \qquad ( Eq . 16 )$$

$$s . t . mlrank ( {B}_{k} ) = ( 6 , 4 , 4 )$$

$$where {B}_{k}^{( t )} = HOSVD ( {T}_{τ ( k )}^{t} - {Γ}_{k}^{( t - 1 )} )$$

Although Equation 16 is not an optimal projection, it is quasi-optimal. Other variants for this projection can also be used.

To solve for the ascent step Γₖ, the update rule can be defined per Equation 17.

$${Γ}_{k}^{( t )} = {Γ}_{k}^{( t - 1 )} + {B}_{k}^{t} - {T}_{τ ( k )}^{t} \qquad ( Eq . 17 )$$

The initialization and details of the ADMM algorithm can now be described as follows: given α, λ, \hat{T} and variables Λ, Bₖ, Γₖ, Tₖ, set T=\hat{T}, Bₖ=HOSVD(T_{τ(k)}), Γₖ=0_{12×12}. The scales may be initialized as Λ_{τ(k)}=1_{12×12×12} given a sufficiently good estimation tensor \hat{T}.

Camera Retrieval. To retrieve cameras from the quadruplet cover, there should be four camera matrices,

$${P}_{i}^{k} , {P}_{j}^{k} , {P}_{q}^{k} , {P}_{l}^{k} ,$$

for each quadruplet. A quadruplet τ(1) can be fixed by retrieving the camera matrices for this quadruplet. A quadruplet τ₂ that overlaps in 2 indices with τ₁ can be chosen, and the camera matrices for this quadruplet can be retrieved. Since the camera matrices overlap in 2 indices, all the cameras may be brought to the same projective frame. Since all quadruplets overlap in at least two camera matrices with another quadruplet, and all camera matrices are included in at least one quadruplet, this process can be iterated until all of the quadruplets are run through and all camera matrices are retrieved.

### Additional Constraints and Extensions

In [47], the P-Rank variety was introduced and characterized for a single trifocal tensor. The P-rank concerns the projections of the tensor onto two of the modes and the rank of the resulting points in the image of the projection. In other words, linear combinations of the slices can be taken in the three different modes, and these linear combinations may be low rank. [47] characterized the P-Rank for a single trifocal tensor to be (2, 3, 3). The block trifocal tensor may have a low P-Rank, even though the size of the matrices may be 3n×3n. This is a stronger constraint on the block trifocal tensor, which may be used to develop better algorithms.

The exemplary system and method are not limited to trifocal tensors, and may be extended to quadrifocal tensors. The quadrifocal tensor is the analogue of the fundamental matrix and the trifocal tensor for the case of 4 views. More details on the quadrifocal tensor can be found in [48]. Individual 3×3×3×3 quadrifocal tensors can be stacked to a 3n×3n×3n×3n block quadrifocal tensor. This block quadrifocal tensor may also exhibit a low multilinear rank. The algorithms described above (e.g., algorithms in FIGS. 3A-3B, ADMM algorithm) may be extended to synchronize the block quadrifocal tensor and further improve the quality of current structure from motion algorithms in ways that the trifocal tensor can not.

### EXPERIMENTAL RESULTS AND ADDITIONAL EXAMPLES

A study was conducted to develop an exemplary method for synchronizing trifocal tensors using a low multilinear rank constraint on the block tensor. The study tested the synchronization algorithm (shown in FIG. 3B) on two benchmark real datasets, the EPFL datasets [39] and the Photo Tourism datasets [11]. Algorithm 300b performed better in the calibrated setting, and since the calibration matrix was usually known in practice, the study restricted the scope of experiments to calibrated trifocal tensors. The study compared two state-of-the-art (SoA) synchronization operations on two view measurements, the Nonconvex Robust Factorization Method (NRFM) [18] and the Linear Unbiased Discriminant (LUD) [12]. NRFM relies on nonconvex optimization and requires a good initialization. The study tested NRFM with an initialization obtained from LUD and with a random initialization.

EPFL Dataset. For EPFL, the study followed the experimental setup and adopted code from [40], and tested an entire structure from the motion pipeline using the exemplary method. Table 2 shows the structure of the motion pipeline for EPFL experiments.

TABLE 2

| Steps | Description |
|---|---|
| 1 | Feature detection and feature matching: The study adopted code from [41] and started |
| | by matching pairs of images using SIFT features. Outlier matches were rejected by |
| | estimating a fundamental matrix using random sample consensus (RANSAC). The |
| | study further screened the pair matches using a Feature Correspondence Check (FCC) |
| | [42]. Keypoints across a triplet of cameras were matched from pairs and were included |
| | only if they appeared in all the pair combinations of the three images. |
| 2 | Estimation and refinement of trifocal tensors: With the triplet matches, the study |
| | calculated the trifocal tensors with more than 11 correspondences. The study applied |
| | Statistical Error Estimation (STE) from [38] to find 40% of the correspondences as |
| | inliers, then used at most 30 inlier point correspondences to linearly estimate the |
| | trifocal tensor. To refine the estimates, the study applied bundle adjustment on the |
| | inliers and deleted triplets with reprojection errors larger than 1 pixel. |
| 3 | Synchronization: The study synchronized the estimated block trifocal tensor with a |
| | robust variant of SVD using the framework shown in FIG. 3B. The robustness came |
| | from replacing SVD with a robust subspace recovery method [38]. The cameras the |
| | study retrieved were up to a global projective ambiguity. When comparing with |
| | ground truth poses, the study first aligned estimated cameras with the ground truth |
| | cameras by finding a 4 × 4 projective transformation. Then the study rounded the |
| | cameras to calibrated cameras and compared. |

The study tested the full pipeline on two EPFL datasets on a personal machine with a 2 GHz Intel Core i5 with 4 cores and 16 GB of memory. To test NRFM [18] and LUD [12], the study estimated the corresponding essential matrices using the MATLAB built-in RANSAC estimator. The study did not include blocks corresponding to two views in our trifocal tensor pipeline. The study did not run CastleP19 or CastleP30 due to a low completion rate of the estimated block trifocal tensor. HerzP25 had only 24 cameras used for the exemplary method due to the existence of a camera with no trifocal tensor estimations. HerzP8 was missing a comparison with other methods because the translations could not be estimated.

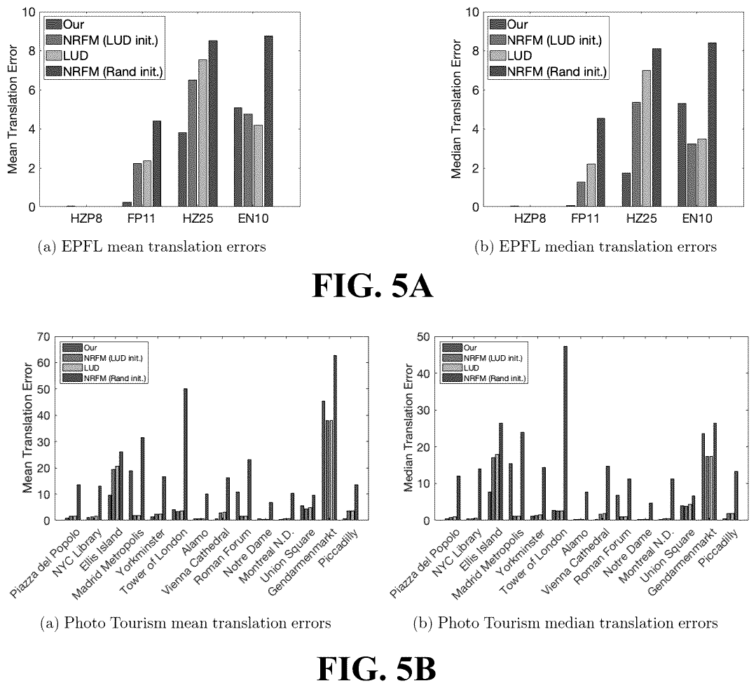

FIGS. 5A-5B show the mean and median translation errors of the exemplary and SoA synchronization methods running on the EFPL and Photo Tourism datasets. The SoA synchronization methods included LUD, NRFM initialized with LUD, i.e., NRFM (LUD init.), and randomly initialized NRFM, i.e., NRFM (Rand init.).

FIG. 5A shows the mean and median translation errors of the exemplary and SoA synchronization methods running on the EPFL datasets, e.g., HerzP8 (HerzP8), FountainP11 (FP11), HerzP25 (HZ25), and EntryP10 (EN10). As shown in subpanels (a) and (b), the exemplary method (referred to as Our) outperformed the SoA methods by producing the fewest mean and median translation errors during the synchronization of trifocal tensors on the EPFL datasets.

Table 3 shows the detail synchronization errors of the exemplary method and SoA methods for EPFL datasets.

TABLE 3

| | Exemplary synchronization method | | | | NRFM(LUD) | | | |
|---|---|---|---|---|---|---|---|---|
| Dataset | R̅ | \hat{R} | T̅ | \hat{T} | R̅ | \hat{R} | T̅ | \hat{T} |
| FountainP11 | 1.52 | 0.66 | 0.22 | 0.08 | 0.28 | 0.23 | 2.22 | 1.29 |
| HerzP25 | 21.44 | 9.88 | 3.81 | 1.74 | 0.25 | 0.19 | 6.50 | 5.37 |
| HerzP8 | 0.28 | 0.27 | 0.05 | 0.03 | n/a | n/a | n/a | n/a |
| EntryP10 | 54.12 | 38.90 | 5.06 | 5.30 | 0.50 | 0.46 | 4.74 | 3.22 |

| | LUD | | | | NRFM(Rand) | | | |
|---|---|---|---|---|---|---|---|---|
| Dataset | R̅ | \hat{R} | T̅ | \hat{T} | R̅ | \hat{R} | T̅ | \hat{T} |
| FountainP11 | 0.28 | 0.23 | 2.36 | 2.21 | 0.28 | 0.23 | 4.39 | 4.53 |
| HerzP25 | 0.25 | 0.19 | 7.53 | 7.00 | 0.25 | 0.19 | 8.50 | 8.09 |
| HerzP8 | n/a | n/a | n/a | n/a | n/a | n/a | n/a | n/a |
| EntryP10 | 0.50 | 0.46 | 4.18 | 3.48 | 0.50 | 0.46 | 8.73 | 8.40 |

As shown in Table 3, R is the mean rotation error in degrees, R is the median rotation error in degrees. T is the mean translation error, i is the median translation error. NRFM(LUD) is a Nonconvex Robust Factorization Method (NRFM) initialized with LUD, and NRFM(Rand) is randomly initialized.

Photo Tourism. The study tested the exemplary method, e.g., described in relation to FIG. 4B, on the Photo Tourism datasets. The Photo Tourism datasets consisted of internet images of real-world scenes. Each scene had hundreds to thousands of images. The datasets [11] provided essential matrix estimates, and the study estimated the trifocal tensors from the given essential matrices. To limit the computational cost for tensors, the study down-sampled the datasets by choosing cameras with observations of more than a certain percentage in the corresponding block frontal slice while maintaining a decent number of cameras. Note that this may not be the optimal way of extracting a dense subset in general.

The maximum number of cameras the study selected for each dataset was 225 cameras. The largest dataset, Piccadilly, had 2031 cameras initially. The study randomly sampled 1000 cameras and then ran the exemplary method. For the Roman Forum and Piccadilly, the two-view methods further deleted cameras from the robust rotation estimation process or parallel rigidity test. The study reran the trifocal tensor synchronization algorithm with the further down-sampled data. The study initialized the hard thresholding parameters for HOSVD-HT by first imputing the trifocal tensor with small random entries and then calculating the singular values for each of the flattening. The study took lᵢ to be the tertile singular value for each mode-i flattening. The study kept this parameter fixed for the synchronization process.

The jii blocks in the block trifocal tensor corresponded to elements in the essential matrix Eᵢⱼ. The study also included these essential matrix estimations in the block trifocal tensor. The study ran the Photo Tourism experiments on an HPC center with 32 cores.

FIG. 5B shows the mean and median translation errors of the exemplary and SoA synchronization methods running on the Photo Tourism datasets. As shown in subpanels (a) and (b), the exemplary method (referred to as Our) outperformed the SoA methods by producing the fewest mean and median translation errors during the synchronization of trifocal tensors on the Photo Tourism datasets.

Tables 4A and 4B show the detailed translation errors of the exemplary method and SoA methods for the Photo Tourism datasets.

TABLE 4A

| | Exemplary synchronization method | | | | | NRFM(LUD) | |
|---|---|---|---|---|---|---|---|
| Dataset | N | n | Est. % | T̅ | \hat{T} | T̅ | \hat{T} |
| Piazza del Popolo | 307 | 185 | 72.3 | 0.78 | 0.45 | 1.63 | 0.85 |
| NYC Library | 306 | 127 | 64.7 | 1.01 | 0.53 | 1.39 | 0.48 |
| Ellis Island | 223 | 194 | 70.3 | 9.56 | 7.73 | 19.31 | 16.97 |
| Tower of London | 440 | 130 | 34.1 | 4.15 | 2.66 | 3.26 | 2.49 |
| Madrid Metropolis | 315 | 190 | 35.9 | 18.93 | 15.53 | 1.91 | 1.19 |
| Yorkminster | 410 | 196 | 37.2 | 1.46 | 1.14 | 2.31 | 1.39 |
| Alamo | 564 | 224 | 94.3 | 0.62 | 0.28 | 0.53 | 0.31 |
| Vienna Cathedral | 770 | 197 | 97.8 | 0.73 | 0.33 | 2.96 | 1.64 |
| Roman Forum(PR) | 989 | 111 | 51.1 | 10.71 | 6.75 | 1.59 | 0.89 |
| Notre Dame | 547 | 214 | 96.6 | 0.57 | 0.34 | 0.38 | 0.21 |
| Montreal N.D. | 442 | 162 | 97.0 | 0.38 | 0.24 | 0.56 | 0.37 |
| Union Square | 680 | 144 | 28.6 | 5.64 | 3.99 | 4.31 | 3.76 |
| Gendarmenmarkt | 655 | 112 | 89.7 | 45.34 | 23.63 | 37.93 | 17.35 |
| Piccadilly(PR) | 1000 | 169 | 55.4 | 0.73 | 0.39 | 3.68 | 1.90 |

TABLE 4B

| | |
|---|---|
| LUD | NRFM (Rand) |

| Dataset | T̅ | \hat{T} | T̅ | \hat{T} |
|---|---|---|---|---|
| Piazza del Popolo | 1.66 | 0.86 | 13.45 | 12.06 |
| NYC Library | 1.49 | 0.57 | 13.06 | 14.03 |
| Ellis Island | 20.71 | 17.96 | 26.08 | 26.38 |
| Tower of London | 3.54 | 2.51 | 49.99 | 47.33 |
| Madrid Metropolis | 1.94 | 1.20 | 31.48 | 24.02 |
| Yorkminster | 2.35 | 1.45 | 16.67 | 14.46 |
| Alamo | 0.53 | 0.31 | 10.04 | 7.68 |
| Vienna Cathedral | 3.15 | 1.79 | 16.08 | 14.76 |
| Roman Forum(PR) | 1.63 | 0.93 | 23.23 | 11.20 |
| Notre Dame | 0.38 | 0.21 | 6.87 | 4.75 |
| Montreal N.D. | 0.57 | 0.38 | 10.33 | 11.15 |
| Union Square | 4.85 | 4.38 | 9.59 | 6.69 |
| Gendarmenmarkt | 37.92 | 17.41 | 62.69 | 26.42 |
| Piccadilly(PR) | 3.71 | 1.93 | 13.55 | 13.34 |

As shown in Tables 4A and 4B, N is the total number of cameras, n is the size after downsampling, Est. % is the ratio of observed blocks over the total number of blocks, T is the mean translation error, i is the median translation error, NRFM(LUD) is NRFM initialized with LUD, and NRFM(Rand) is randomly initialized. The notation PR refers to the dataset being further down-sampled to match the two-view methods.

The exemplary method achieved competitive translation errors on 8 of the 14 datasets tested. The exemplary algorithm performed well when the viewing graph was dense or, in other words, when the estimation percentage was high. The exemplary method achieved better locations in 6 out of 8 datasets, where the estimation percentage exceeded 60% and better locations in only 2 out of 6 datasets where the estimation percentage fell below 60%.

The exemplary method achieved reasonable rotation estimations for 10 out of 14 datasets, but not as good as LUD. Table 5 shows the rotation errors of the exemplary method and SoA methods for the Photo Tourism datasets.

Since the block trifocal tensor scaled cubically with respect to the number of cameras, the exemplary algorithm runtime was longer than most two-view global methods. This may be resolved by synchronizing dense subsets in parallel and merging the results to construct a larger reconstruction.

TABLE 5

| | Exemplary synchronization method | | | | | LUD | | |
|---|---|---|---|---|---|---|---|---|
| Dataset | N | n | Est. % | R̅ | \hat{R} | R̅ | \hat{R} | Runtime (s) |
| Piazza del Popolo | 307 | 185 | 72.3 | 1.26 | 0.61 | 0.72 | 0.43 | 13531 |
| NYC Library | 306 | 127 | 64.7 | 2.80 | 1.58 | 1.16 | 0.61 | 4465 |
| Ellis Island | 223 | 194 | 70.3 | 4.61 | 1.11 | 1.16 | 0.50 | 13816 |
| Tower of London | 440 | 130 | 34.1 | 2.28 | 1.31 | 1.63 | 1.28 | 4242 |
| Madrid Metropolis | 315 | 190 | 35.9 | 28.85 | 4.60 | 1.27 | 0.61 | 11764 |
| Yorkminster | 410 | 196 | 37.2 | 2.33 | 1.97 | 1.34 | 1.09 | 13115 |
| Alamo | 564 | 224 | 94.3 | 1.10 | 0.76 | 1.07 | 0.68 | 17513 |
| Vienna Cathedral | 770 | 197 | 97.8 | 0.74 | 0.46 | 0.40 | 0.28 | 12499 |
| Roman Forum(PR) | 989 | 111 | 51.1 | 11.86 | 3.39 | 0.40 | 0.28 | 2162 |
| Notre Dame | 547 | 214 | 96.6 | 0.78 | 0.50 | 0.67 | 0.43 | 17430 |
| Montreal N.D. | 442 | 162 | 97.0 | 0.50 | 0.35 | 0.49 | 0.32 | 7241 |
| Union Square | 680 | 144 | 28.6 | 20.70 | 5.29 | 1.82 | 1.34 | 4355 |
| Gendarmenmarkt | 655 | 112 | 89.7 | 22.95 | 15.24 | 18.42 | 10.25 | 2432 |
| Piccadilly(PR) | 1000 | 169 | 55.4 | 2.01 | 0.96 | 6.12 | 2.95 | 11230 |

As shown in Table 5, N is the total number of cameras, n is the size after down sampling, Est. % is the ratio of observed blocks over the total number of blocks, K is the mean rotation error, R is the median rotation error, NRFM(LUD) is NRFM initialized with LUD, and NRFM(Rand) is randomly initialized. The notation PR means that the dataset was further down-sampled to match the two-view methods.

In the experiments, the instant study synchronized the trifocal tensors with the exemplary method and achieved a mean rotation error of 0.61 degrees, median rotation error of 0.49 degrees, mean location error of 0.76, and median location error of 0.74.

Results of Distributed Synchronization. Table 6 compares results for the non-distributed synchronization and the distributed synchronization on the Photo Tourism dataset.

TABLE 6

| | | Rel | | | | | Non-dis | Dis |
|---|---|---|---|---|---|---|---|---|
| Dataset | #cams | diff | ē_{T} | ê_{T} | ē_{R} | ê_{R} | sync time | sync time |
| NYC | 127 | 0.0516 | 1.1216 | 0.6134 | 2.5245 | 1.4892 | 4465 | 1365.17 |
| Alamo | 224 | 0.0285 | 3.6144 | 2.7876 | 1.3818 | 0.9502 | 17513 | 1547.51 |
| Yorkminster | 196 | 0.0439 | 1.5092 | 0.8737 | 2.2639 | 1.5853 | 13115 | 1516.64 |
| Notre Dame | 214 | 0.0438 | 0.6742 | 0.4205 | 1.0933 | 0.8108 | 17430 | 1224.74 |
| Montreal | 162 | 0.0176 | 0.4288 | 0.2621 | 0.7621 | 0.5691 | 7241 | 948.40 |
| N.D. | | | | | | | | |
| Ellis Island | 194 | 0.1517 | 14.8342 | 12.6637 | 4.7399 | 1.6037 | 13816 | 1437.00 |
| Piazza Del | 185 | 0.0260 | 0.7262 | 0.3927 | 1.1542 | 0.7276 | 13531 | 1774.64 |
| Popolo | | | | | | | | |

In Table 6, ē_{T}, ê_{T}, ē_{R}, ê_{R} represent the mean location error, median location error, mean rotation error, and median rotation error, respectively; Rel diff=relative difference; Non-dis sync time=time for non-distributed synchronization; Dis sync time=time for distributed synchronization.

In Table 6, with no loss of accuracy, the distributed synchronization sped up the computation of some datasets by more than 10 times compared to the non-distributed synchronization. The computation speed could be limited by the size of each subproblem when enough computing units were present. The exemplary method with the distributed synchronization approach may be scalable for large-scale applications and applicable to critical developments such as robotics, autonomous vehicles, and geographical mapping.

### DISCUSSION

The instant study developed and evaluated a method and associated system for synchronizing trifocal tensors using a low multilinear rank constraint on the block tensor.

Synchronization is crucial for the success of many data-intensive applications, including structure from motion, simultaneous localization and mapping (SLAM), and community detection. This problem involves estimating global states from relative measurements between states. While many studies have explored synchronization in different contexts using pairwise measurements, few have considered measurements between three or more states. In real-world scenarios, relying solely on pairwise measurements often fails to capture the full complexity of the system. For instance, in networked systems, interactions frequently occur among groups of nodes, necessitating approaches that can handle higher-order relationships. Extending synchronization to consider measurements between three or more states, however, increases computational complexity and requires sophisticated mathematical models. Addressing these challenges is vital for advancing various technological fields. For example, higher-order synchronization can improve the accuracy of 3D reconstructions in structure from motion by leveraging more complex geometric relationships. In the instant study, the prototype (e.g., SLAM) can enhance the mapping and localization precision in dynamic environments by considering multi-robot interactions. Similarly, in social networks, it may be employed for the more accurate identification of tightly-knit groups. Developing efficient algorithms to handle higher-order measurements will open new research avenues and make systems more resilient and accurate.

In the structure of motion problems, synchronization has traditionally been done using incremental methods, such as Bundler [2] and COLMAP [3]. These methods process images sequentially, gradually recovering camera poses. However, the order of image processing may impact reconstruction quality, as errors may significantly accumulate. Bundle adjustment [4], which jointly optimizes camera parameters and 3D points, has been used to limit drifting but is computationally expensive.

Alternatively, global synchronization methods have been developed. These methods process multiple images simultaneously, avoiding iterative procedures and offering more rigorous and robust solutions. Global methods generally optimize noisy and corrupted measurements by exploiting the structure of relative measurements and imposing constraints. Many global methods solve for orientation and location separately, using structures on SO(3) and the set of locations. Solutions for retrieving camera poses from pairwise measurements have been developed for camera orientations [5]-[10], camera locations [11]-[13], and both simultaneously [14]-[17]. Some methods explore the structure of fundamental or essential matrices [18]-[20].

Several attempts to extract information from trifocal tensors include works by Leonardos et al. [21], which parameterizes calibrated trifocal tensors with non-collinear pinhole cameras as a quotient Riemannian manifold and uses the manifold structure to estimate individual trifocal tensors robustly; Larsson et al. [22], which proposes minimal solvers to determine calibrated radial trifocal tensors for use in an incremental pipeline, handling distorted images with constraints invariant to radial displacement; and Moulon et al. [23], which introduces a structure from motion pipeline, retrieving global rotations via cleaning the estimation graph and solving a least squares problem, and solving for translations by estimating trifocal tensors individually by linear programs. No previous studies have developed a global pipeline where the synchronization operates directly on trifocal tensors.

### CONCLUSION

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include one particular value and/or the other particular value.

By “comprising” or “containing” or “including,” is meant that at least the name compound, element, particle, or method step is present in the composition or article or method but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The following patents, applications and publications as listed below and throughout this document are hereby incorporated by reference in their entirety herein.
[1] Richard Hartley and Andrew Zisserman. Multiple View Geometry in Computer Vision. Cambridge University Press, 2003.
[2] Noah Snavely, Steven Seitz, and Richard Szeliski. Photo Tourism: Exploring photo collections in 3D. In Proceedings of the ACM Special Interest Group on Computer Graphics and Interactive Techniques Conference, SIGGRAPH 2006, pages 835-846, 2006.
[3] Johannes Schonberger and Jan-Michael Frahm. Structure-from-motion revisited. In Proceedings of the IEEE Conference on Computer Vision and Pattern Recognition, CVPR 2016, pages 4104-4113, 2016.
[4] Bill Triggs, Philip McLauchlan, Richard Hartley, and Andrew Fitzgibbon. Bundle adjustment—A modern synthesis. In Bill Triggs, Andrew Zisserman, and Richard Szeliski, editors, Vision Algorithms: Theory and Practice, pages 298-372, Berlin, Heidelberg, 2000. Springer Berlin Heidelberg.
[5] Venu Madhav Govindu. Lie-algebraic averaging for globally consistent motion estimation. In Proceedings of the IEEE Conference on Computer Vision and Pattern Recognition, CVPR 2004, volume 1, pages 1-8, 2004.
[6] Richard Hartley, Jochen Trumpf, Yuchao Dai, and Hongdong Li. Rotation averaging. International Journal of Computer Vision, 103:267-305, 2013.
[7] Avishek Chatterjee and Venu Madhav Govindu. Robust relative rotation averaging. IEEE Transactions on Pattern Analysis and Machine Intelligence, 40(4):958-972, 2018.
[8] Avishek Chatterjee and Venu Madhav Govindu. Efficient and robust large-scale rotation averaging. In Proceedings of the IEEE International Conference on Computer Vision, ICCV 2013, pages 521-528, 2013.
[9] Yunpeng Shi and Gilad Lerman. Message passing least squares framework and its application to rotation synchronization. In Proceedings of the International Conference on Machine Learning, ICML 2020, pages 8796-8806, 2020.
[10] Mica Arie-Nachimson, Shahar Kovalsky, Ira Kemelmacher-Shlizerman, Amit Singer, and Ronen Basri. Global motion estimation from point matches. In Proceedings of the International Conference on 3D Imaging, Modeling, Processing, Visualization & Transmission, 3DIMPVT 2012, pages 81-88, 2012.
[11] Kyle Wilson and Noah Snavely. Robust global translations with 1DSfM. In Proceedings of the European Conference on Computer Vision, EECV 2014, pages 61-75, 2014.
[12] Onur Ozyesil and Amit Singer. Robust camera location estimation by convex programming. In Proceedings of the IEEE Conference on Computer Vision and Pattern Recognition, CVPR 2015, pages 2674-2683, 2015.
[13] Thomas Goldstein, Paul Hand, Choongbum Lee, Vladislav Voroninski, and Stefano Soatto. ShapeFit and ShapeKick for robust, scalable structure from motion. In Proceedings of the European Conference on Computer Vision, EECV 2016, pages 289-304, 2016.
[14] David Rosen, Luca Carlone, Afonso Bandeira, and John Leonard. SE-Sync: A certifiably correct algorithm for synchronization over the special Euclidean group. International Journal of Robotics Research, 38(2-3):95-125, 2019.
[15] Federica Arrigoni, Beatrice Rossi, and Andrea Fusiello. Spectral synchronization of multiple views in SE(3). SIAM Journal on Imaging Sciences, 9(4):1963-1990, 2016.
[16] Mihai Cucuringu, Yaron Lipman, and Amit Singer. Sensor network localization by eigenvector synchronization over the Euclidean group. ACM Transactions on Sensor Networks, 8(3), 2012.
[17] Jesus Briales and Javier Gonzalez-Jimenez. Cartan-Sync: Fast and global SE(d)-synchronization. IEEE Robotics and Automation Letters, 2(4):2127-2134, 2017.
[18] Soumyadip Sengupta, Tal Amir, Meirav Galun, Tom Goldstein, David Jacobs, Amit Singer, and Ronen Basri. A new rank constraint on multi-view fundamental matrices, and its application to camera location recovery. In Proceedings of the IEEE Conference on Computer Vision and Pattern Recognition, CVPR 2017, pages 4798-4806, 2017.
[19] Yoni Kasten, Amnon Geifman, Meirav Galun, and Ronen Basri. Algebraic characterization of essential matrices and their averaging in multiview settings. In Proceedings of the IEEE Conference on Computer Vision and Pattern Recognition, CVPR 2019, pages 5895-5903, 2019.
[20] Yoni Kasten, Amnon Geifman, Meirav Galun, and Ronen Basri. GPSfM: Global projective SFM using algebraic constraints on multi-view fundamental matrices. In Proceedings of the IEEE Conference on Computer Vision and Pattern Recognition, CVPR 2019, pages 3264-3272, 2019.
[21] Spyridon Leonardos, Roberto Tron, and Kostas Daniilidis. A metric parametrization for trifocal tensors with non-colinear pinholes. In Proceedings of the IEEE Conference on Computer Vision and Pattern Recognition, CVPR 2015, pages 259-267, 2015.
[22] Viktor Larsson, Nicolas Zobernig, Kasim Taskin, and Marc Pollefeys. Calibration-free structure-from-motion with calibrated radial trifocal tensors. In Proceedings of the European Conference on Computer Vision, EECV 2020, pages 382-399, 2020.
[23] Pierre Moulon, Pascal Monasse, and Renaud Marlet. Global fusion of relative motions for robust, accurate and scalable structure-from-motion. In Proceedings of the IEEE Conference on Computer Vision and Pattern Recognition, CVPR 2013, pages 3248-3255, 2013.
[24] Joe Kileel. Minimal problems for the calibrated trifocal variety. SIAM Journal on Applied Algebra and Geometry, 1(1):575-598, 2017.
[25] Timothy Duff, Kathlen Kohn, Anton Leykin, and Tomas Pajdla. PLMP-point-line minimal problems in complete multi-view visibility. In Proceedings of the IEEE Conference on Computer Vision and Pattern Recognition, CVPR 2019, pages 1675-1684, 2019.
[26] Ricardo Fabbri, Timothy Duff, Hongyi Fan, Margaret Regan, David da Costa de Pinho, Elias Tsigaridas, Charles Wampler, Jonathan Hauenstein, Peter Giblin, Benjamin Kimia, Anton Leykin, and Tomas Pajdla. Trifocal relative pose from lines at points. IEEE Transactions on Pattern Analysis and Machine Intelligence, 45(6):7870-7884, 2023.
[27] David Nister and Henrik Stewenius. A minimal solution to the generalised 3-point pose problem. Journal of Mathematical Imaging and Vision, 27(1):67-79, 2007.
[28] Ali Elqursh and Ahmed Elgammal. Line-based relative pose estimation. In Proceedings of the IEEE Conference on Computer Vision and Pattern Recognition, CVPR 2011, pages 3049-3056, 2011.
[29] Yubin Kuang and Kalle Astrom. Pose estimation with unknown focal length using points, directions and lines. In Proceedings of the IEEE Conference on Computer Vision and Pattern Recognition, CVPR 2013, pages 529-536, 2013.
[30] Zuzana Kukelova, Joe Kileel, Bernd Sturmfels, and Tomas Pajdla. A clever elimination strategy for efficient minimal solvers. In Proceedings of the IEEE Conference on Computer Vision and Pattern Recognition, CVPR 2017, pages 4912-4921, 2017.
[31] Pedro Miraldo, Tiago Dias, and Srikumar Ramalingam. A minimal closed-form solution for multi-perspective pose estimation using points and lines. In Proceedings of the European Conference on Computer Vision, ECCV 2018, pages 474-490, 2018.
[32] Onur Ozyesil, Vladislav Voroninski, Ronen Basri, and Amit Singer. A survey of structure from motion. Acta Numerica, 26:305-364, 2017.
[33] Tamara Kolda and Brett Bader. Tensor decompositions and applications. SIAM Review, 51(3):455-500, 2009.
[34] Tommi Muller, Adriana Duncan, Eric Verbeke, and Joe Kileel. Algebraic constraints and algorithms for common lines in cryo-EM. Biological Imaging, pages 1-30, Published online 2024.
[35] Rahul Mazumder, Trevor Hastie, and Robert Tibshirani. Spectral regularization algorithms for learning large incomplete matrices. Journal of Machine Learning Research, 11:2287-2322, 2010.
[36] Nathan Halko, Per-Gunnar Martinsson, and Joel Tropp. Finding structure with randomness: Probabilistic algorithms for constructing approximate matrix decompositions. SIAM Review, 53(2):217-288, 2011.
[37] David Tyler. A distribution-free M-estimator of multivariate scatter. Annals of Statistics, pages 234-251, 1987.
[38] Feng Yu, Teng Zhang, and Gilad Lerman. A subspace-constrained Tyler's estimator and its applications to structure from motion. arXiv preprint arXiv:2404.11590, 2024.
[39] Christoph Strecha, Wolfgang Von Hansen, Luc Van Gool, Pascal Fua, and Ulrich Thoennessen. On benchmarking camera calibration and multi-view stereo for high resolution imagery. In Proceedings of the IEEE Conference on Computer Vision and Pattern Recognition, CVPR 2008, pages 1-8, 2008.
[40] Laura Julia and Pascal Monasse. A critical review of the trifocal tensor estimation. In Proceedings of the Pacific Rim Symposium on Image and Video Technology, PSIVT 2017, Revised Selected Papers 8, pages 337-349. Springer, 2018.
[41] Shaohan Li, Yunpeng Shi, and Gilad Lerman. Fast, accurate and memory-efficient partial permutation synchronization. In Proceedings of the IEEE Conference on Computer Vision and Pattern Recognition, CVPR 2022, pages 15735-15743, 2022.
[42] Yunpeng Shi, Shaohan Li, Tyler Maunu, and Gilad Lerman. Scalable cluster-consistency statistics for robust multi-object matching. In Proceedings of the International Conference on 3D Vision, 3DV 2021, pages 352-360, 2021.
[43] Joe Harris. Algebraic Geometry: A First Course, volume 133. Springer Science & Business Media, 1992.
[44] Ying Sun, Prabhu Babu, and Daniel Palomar. Regularized Tyler's scatter estimator: Existence, uniqueness, and algorithms. IEEE Transactions on Signal Processing, 62(19):5143-5156, 2014.
[45] George Karypis and Vipin Kumar. A hypergraph partitioning package. Army HPC Research Center, Department of Computer Science & Engineering, University of Minnesota, 2:1-20, 1998.
[46] Yoni Kasten, Amnon Geifman, Meirav Galun, and Ronen Basri. Gpsfm: Global projective sfm using algebraic constraints on multi-view fundamental matrices. In Proceedings of the IEEE/CVF Conference on Computer Vision and Pattern Recognition, pages 3264-3272, 2019.
[47] Chris Aholt and Luke Oeding. The ideal of the trifocal variety. Mathematics of Computation, 83(289):2553-2574, 2014.
[48] Richard Hartley and Andrew Zisserman. Multiple view geometry in computer vision. Cambridge University Press, 2003.
[49] Daniel Miao, Gilad Lerman, Joe Kileel, “Tensor-based synchronization and the low-rankness of the block trifocal tensor”, Advances in Neural Information Processing Systems, 2024, pp. 1-28

What is claimed:

1. A method comprising:
receiving a plurality of images acquired from a plurality of cameras, including a first camera and a second camera;
reconstructing, via a computer vision application, a 3D world scene from the plurality of images;
determining, via a synchronization operation, a global tensor estimate or a camera global tensor estimate using triplewise or quadruplewise relative pose estimates, wherein individual triplewise or quadruplewise relative pose estimates (i) employ one or more arrays comprising a subset of trifocal or quadrifocal tensors defined up to nonzero scales and (ii) assemble the array blockwise into one or more tensors; and
outputting the global tensor estimate or the camera instance global tensor estimate for visualization or control.

2. The method of claim 1, wherein the synchronization operation is performed in a distributed manner, the synchronization operation comprising:
distributing the plurality of images among a set of computing resources, wherein each computing resource is configured to perform a portion of the synchronization operation for a subset of the plurality of images to determine a subset of the triplewise or quadruplewise relative pose estimates; and
merging the subset of triplewise or quadruplewise relative pose estimates for the subsets of the plurality of images.

3. The method of claim 1 further comprising:
updating the global tensor estimates to remove noise and provide fuller observation using an iterative algorithm to compute correct scales, impute missing blocks, and denoise the global tensor; and
performing imputation of synchronization by (i) computing a higher-order singular value decomposition or an alternating direction method of multipliers and (ii) reading off the global configuration from the factor matrices.

4. The method of claim 1, wherein the plurality of images is utilized in a photo tourism app.

5. The method of claim 3, comprising:
applying a constraint low-multilinear rank operation in the synchronization operation.

6. The method of claim 5, wherein the constraint low-multilinear rank is determined via explicit Tucker factorization of the tensor.

7. The method of claim 5, wherein the constraint low-multilinear rank is (6,4,4).

8. The method of claim 5, wherein the constraint low-multilinear rank is (4, 6, 4), (4, 4, 6), or other permutations thereof.

9. The method of claim 5, wherein the constraint low-multilinear rank is (4,4,4,4) when the one or more tensors are quadrifocal.

10. The method of claim 5, wherein the one or more tensors have a constraint low-multilinear rank and low p-rank, wherein the p-rank is (4,3,3) when the one or more tensors are trifocal, and wherein ranks of random linear combinations of matrix slices of the one or more tensors are (4,4,4,4,4,4) when the one or more tensors are quadrifocal.

11. The method of claim 1, wherein the synchronization operation employs a Tyler M estimator for subspace recovery.

12. The method of claim 1, wherein the synchronization operation, as a distributed operation, comprises:
partitioning a dataset into k parts so that each overlapping partition has at most a pre-defined number of cameras;
labeling the partitions and adding 2×k cameras from the (i+1)th partition into the ith partition, where the added cameras from the (i+1)th partition are a densest connected cameras to the ith partition;
synchronizing each sub-dataset using the tensor synchronization algorithm; and
computing a homography using the overlapping cameras and bringing all subproblems to a same projective or calibrated frame to achieve a large reconstruction.

13. The method of claim 9, wherein overlapping partitions have the same or different cameras, and wherein the overlapping partitions have at least 10 indices or cameras in common.

14. A non-transitory computer-readable medium having instructions stored thereon, wherein execution of the instructions by a processor causes the processor to:
receive a plurality of images acquired from a plurality of cameras, including a first camera and a second camera;
reconstruct, via a computer vision application, a 3D world scene from the plurality of images;
determine, via a synchronization operation, a global tensor estimate or a camera global tensor estimate using triplewise or quadruplewise relative pose estimates, wherein individual triplewise or quadruplewise relative poses (i) employ one or more arrays comprising a subset of trifocal or quadrifocal tensors defined up to nonzero scales and (ii) assemble the array blockwise into one or more tensors; and
output the global tensor estimate or the camera instance global tensor estimate for visualization or control.

15. The non-transitory computer-readable medium of claim 14, wherein the execution of the instructions further causes the processor to:
update the global tensor estimates to remove noise and provide fuller observation using an iterative algorithm to compute correct scales, impute missing blocks, and denoise the global tensor; and
perform imputation of synchronization by (i) computing a higher-order singular value decomposition or an alternating direction method of multipliers and (ii) reading off the global configuration from the factor matrices.

16. The non-transitory computer-readable medium of claim 15, wherein the execution of the instructions further causes the processor to:
apply a constraint low-multilinear rank operation in the synchronization operation.

17. The non-transitory computer-readable medium of claim 16, wherein the constraint low-multilinear rank is determined via explicit Tucker factorization of the tensor.

18. The non-transitory computer-readable medium of claim 16, wherein the constraint low-multilinear rank is (6,4,4) when the one or more tensors are trifocal, and wherein the constraint low-multilinear rank is (4,4,4,4) when the one or more tensors are quadrifocal.

19. A system comprising:
a processor; and
a memory having instructions stored thereon, wherein execution of the instructions by the processor causes the processor to:
receive a plurality of images acquired from a plurality of cameras, including a first camera and a second camera;
reconstruct, via a computer vision application, a 3D world scene from the plurality of images;
determine, via a synchronization operation, a global tensor estimate or a camera global tensor estimate using triplewise or quadruplewise relative pose estimates, wherein individual triplewise or quadruplewise relative poses (i) employ one or more arrays comprising a subset of trifocal or quadrifocal tensors defined up to nonzero scales and (ii) assemble the array blockwise into one or more tensors; and
output the global tensor estimate or the camera instance global tensor estimate for visualization or control.

20. The system of claim 19, wherein the execution of the instructions further causes the processor to:
update the global tensor estimates to remove noise and provide fuller observation using an iterative algorithm to compute correct scales, impute missing blocks, and denoise the global tensor; and
perform imputation of synchronization by (i) computing a higher-order singular value decomposition or an alternating direction method of multipliers and (ii) reading off the global configuration from the factor matrices.
